(19) United States
(12) Patent Application Publication
(10) Pub. No.: US 2026/0281604 A1
(43) Pub. Date: Sep. 17, 2026

(54) EAR-CLIP EARPHONES

(71) Applicant: SHENZHEN SHOKZ CO., LTD., Shenzhen (CN)

(72) Inventors: Chaojie CUI, Shenzhen (CN); Jiang XU, Shenzhen (CN); Lei ZHONG, Shenzhen (CN); Haochen LIU, Shenzhen (CN); Weijie YUAN, Shenzhen (CN); Lei WANG, Shenzhen (CN)

(73) Assignee: SHENZHEN SHOKZ CO., LTD., Shenzhen (CN)

(21) Appl. No.: 19/674,076

(22) Filed: May 11, 2026

Related U.S. Application Data
(63) Continuation of application No. PCT/CN2024/138270, filed on Dec. 10, 2024.

(30) Foreign Application Priority Data
Dec. 11, 2023 (CN) 202311701969.7
Feb. 6, 2024 (CN) 202410172377.9
Feb. 6, 2024 (WO) PCT/CN2024/076377
Feb. 6, 2024 (WO) PCT/CN2024/076378
Feb. 6, 2024 (WO) PCT/CN2024/076388
Feb. 6, 2024 (WO) PCT/CN2024/076389
Feb. 6, 2024 (WO) PCT/CN2024/076495

(51) Int. Cl. H04R 1/10; H04R 9/06

(52) U.S. Cl. CPC H04R 1/105; H04R 1/1016; H04R 1/1066; H04R 9/06

(57) ABSTRACT

Provided is an ear-clip earphone, including a sound-generating portion, an abutment portion, and an ear hook. The sound-generating portion includes: a housing having an accommodating cavity; a sound-generating assembly accommodated in the accommodating cavity; and a sound outlet hole located on the housing and configured to guide out a sound. In a wearing state, the sound-generating portion is configured to be located in a concha cavity of a user and contact an inner wall of the concha cavity. The abutment portion is configured to abut a rear side of an auricle of the user, and a battery is disposed in the abutment portion. The ear hook is configured to bypass an antihelix and a helix of the user, connect to the sound-generating portion and the abutment portion, and provide a clamping force for clamping the sound-generating portion and the abutment portion on two sides of the auricle.

### CROSS-REFERENCE TO RELATED APPLICATIONS

This application is a continuation of International Patent Application No. PCT/CN2024/138270, filed on Dec. 10, 2024, which claims priority to Chinese Patent Application No. 202311701969.7, filed on Dec. 11, 2023, International Application No. PCT/CN2024/076377, filed on Feb. 6, 2024, International Application No. PCT/CN2024/076495, filed on Feb. 6, 2024, International Application No. PCT/CN2024/076378, filed on Feb. 6, 2024, International Application No. PCT/CN2024/076388, filed on Feb. 6, 2024, International Application No. PCT/CN2024/076389, filed on Feb. 6, 2024, and Chinese Patent Application No. 202410172377.9, filed on Feb. 6, 2024, the entire contents of each of which are hereby incorporated by reference.

### TECHNICAL FIELD

The present disclosure generally relates to the field of earphones, and in particular, to an ear-clip earphone.

### BACKGROUND

Earphones have been widely used in people's daily lives and can be used in conjunction with electronic devices such as mobile phones and computers to provide a user with a sound playback function. Among them, an ear-clip earphone is a new type of earphone which can be used by being clamped onto the helix of the wearer with a clamping force. However, the clamping force increases as the thickness of the clamped auricle increases, resulting in a larger clamping force for a thicker auricle.

Consequently, there is a desire to provide an ear-clip earphone that can reduce a difference in clamping force experienced by a user with small ears and a user with large ears, thereby improving comfort for users with auricles of different thicknesses.

### SUMMARY

One or more embodiments of the present disclosure provide an ear-clip earphone. The ear-clip earphone includes a sound-generating portion, an abutment portion, and an ear hook. In a wearing state, the sound-generating portion is configured to be located in a concha cavity of a user and contact an inner wall of the concha cavity. The sound-generating portion includes a housing having an accommodating cavity, a sound-generating assembly accommodated in the accommodating cavity and configured to convert an electrical signal into an audio signal, and a sound outlet hole located on the housing and configured to guide out a sound generated by the sound-generating assembly. In the wearing state, the abutment portion is configured to abut a rear side of an auricle of the user, and a battery is disposed in the abutment portion. In the wearing state, the ear hook is configured to bypass an antihelix and a helix of the user, connect to the sound-generating portion and the abutment portion, and provide a clamping force for clamping the sound-generating portion and the abutment portion on two sides of the auricle. In a non-wearing state, the ear hook provides a preload force for abutting the sound-generating portion against the abutment portion.

In some embodiments, the ear hook has a first symmetry plane. The housing forms a first projection when projected onto the first symmetry plane, the abutment portion forms a second projection when projected onto the first symmetry plane, and the ear hook forms a third projection when projected onto the first symmetry plane. The third projection includes an inner contour curve. The first projection and the second projection are in contact with each other. The first projection and the second projection have a first common tangent therebetween. The first common tangent is simultaneously tangent to the first projection and the second projection at a first tangent point, and the first tangent point serves as a first feature point. Alternatively, the first projection and the second projection have an overlapping region. In the overlapping region, an outer contour of the first projection and an outer contour of the second projection have two intersection points, and a midpoint of a connecting line of the two intersection points serves as the first feature point. A point on the inner contour curve farthest from the first feature point serves as a second feature point. A connecting line between the first feature point and the second feature point is defined as a first connecting line. A first auxiliary line is drawn from the second feature point toward a side biased toward the first projection. A first included angle between the first auxiliary line and the first connecting line has a first preset value range. The first preset value range is 27°-37°, or greater than 37° and less than or equal to 50°. An intersection point of a curve segment of the inner contour curve connected to the first projection and the first auxiliary line is defined as a third feature point. A connecting line between the third feature point and the second feature point is defined as a second connecting line. A portion of the inner contour curve corresponding to the second connecting line has a first arc length. A ratio between the first arc length and a length of the second connecting line is defined as a first arc-to-chord ratio. The first arc-to-chord ratio is in a range of 1.10 to 1.25, or the first arc-to-chord ratio is greater than or equal to 1.05 and less than 1.10. A second auxiliary line is drawn from the second feature point toward a side biased toward the second projection. A second included angle between the second auxiliary line and the first connecting line has a second preset value range. The second preset value range is 34°-49°, or greater than or equal to 20° and less than 34°. An intersection point of a curve segment of the inner contour curve connected to the second projection and the second auxiliary line is defined as a fourth feature point. A connecting line between the fourth feature point and the second feature point is defined as a third connecting line. A portion of the inner contour curve corresponding to the third connecting line has a second arc length. A ratio between the second arc length and a length of the third connecting line is defined as a second arc-to-chord ratio. The second arc-to-chord ratio is in a range of 1.11 to 1.24, or the second arc-to-chord ratio is greater than 1.24 and less than or equal to 1.40.

In some embodiments, a point on the first projection closest to the second feature point serves as a fifth feature point, a connecting line between the fifth feature point and the second feature point serves as a fourth connecting line, an extension line of the fourth connecting line intersects the first projection at a sixth feature point, a connecting line between the fifth feature point and the sixth feature point is defined as a fifth connecting line, a curve segment of the first projection corresponding to the fifth connecting line has a third arc length, a ratio between the third arc length and a length of the fifth connecting line is defined as a third arc-to-chord ratio, and the third arc-to-chord ratio is in a range of 1.4 to 1.7, or the third arc-to-chord ratio is greater than 1.7 and less than or equal to 1.8.

In some embodiments, in a state where the abutment portion is held and the sound-generating portion is freely placed such that the sound-generating portion faces the ground along a gravity direction, the abutment portion contacts the sound-generating portion.

In some embodiments, the preload force is in a range of 0.01 N to 0.25 N.

In some embodiments, an elastic coefficient of the ear hook is in a range of 0.01 N/mm to 0.24 N/mm.

In some embodiments, when a distance between the housing of the sound-generating portion and the abutment portion varies between 3.8 mm and 5.5 mm, the clamping force is in a range of 0.1 N to 0.2 N.

In some embodiments, when a distance between the housing of the sound-generating portion and the abutment portion is 5.5 mm, the clamping force is in a range of 0.14 N to 0.2 N.

In some embodiments, when a distance between the housing of the sound-generating portion and the abutment portion varies between 3.8 mm and 5.5 mm, a variation of the clamping force does not exceed 0.20 N.

In some embodiments, the ear hook includes a titanium sheet and a flexible layer wrapping an outer side of the titanium sheet. Two end portions of the titanium sheet in a length direction of the titanium sheet are respectively connected to the housing and the abutment portion. A dimension of the titanium sheet in a width direction is in a range of 1.5 mm to 3 mm, and a dimension of the titanium sheet in a thickness direction is in a range of 0.15 mm to 0.3 mm.

In some embodiments, a region of the housing abutting against the abutment portion is provided with a flexible body.

In some embodiments, a first magnet is disposed in the sound-generating portion, a second magnet is disposed in the abutment portion, and the first magnet and the second magnet attract each other to compensate the clamping force provided by the sound-generating portion and the abutment portion.

Another aspect of the present disclosure provides an ear-clip earphone. The ear-clip earphone includes a sound-generating portion, an abutment portion, and an ear hook. In a wearing state, the sound-generating portion is configured to be located in a concha cavity of a user and contact an inner wall of the concha cavity. The sound-generating portion includes a housing having an accommodating cavity, a sound-generating assembly accommodated in the accommodating cavity, and a sound outlet hole located on the housing and configured to guide out a sound generated by the sound-generating assembly. In the wearing state, the abutment portion is configured to abut a rear side of an auricle of the user. In the wearing state, the ear hook is configured to bypass an antihelix and a helix of the user, connect to the sound-generating portion and the abutment portion, and provide a clamping force for clamping the sound-generating portion and the abutment portion on two sides of the auricle. A first magnet is disposed in the sound-generating portion, a second magnet is disposed in the abutment portion, and the first magnet and the second magnet attract each other to compensate the clamping force provided by the ear hook for the sound-generating portion and the abutment portion.

### BRIEF DESCRIPTION OF THE DRAWINGS

The present disclosure will be further described by way of exemplary embodiments, which will be described in detail with reference to the accompanying drawings. These embodiments are not limiting, and in these embodiments, the same reference numerals denote the same structures, wherein:

FIG. 1 is a schematic diagram illustrating an exemplary appearance structure of an ear-clip earphone according to some embodiments of the present disclosure;

FIG. 2 is a schematic diagram illustrating an exemplary wearing state of an ear-clip earphone according to some embodiments of the present disclosure;

FIG. 3 is a schematic diagram illustrating an exemplary structure of a cross-section of an ear-clip earphone according to some embodiments of the present disclosure;

FIG. 4 is a schematic diagram illustrating an exemplary preload force according to some embodiments of the present disclosure;

FIG. 5 is a schematic diagram illustrating an exemplary process for obtaining a preload force according to some embodiments of the present disclosure;

FIGS. 6A and 6B are schematic diagrams illustrating an exemplary process for determining two pulling forces and two corresponding distances according to some embodiments of the present disclosure;

FIG. 7 is a schematic diagram illustrating an exemplary process for fitting a preload force based on two pulling forces and two corresponding distances according to some embodiments of the present disclosure;

FIG. 8 is a schematic diagram illustrating an exemplary clamping force according to some embodiments of the present disclosure;

FIG. 9A is a schematic diagram illustrating exemplary linear variations of a clamping force according to some embodiments of the present disclosure;

FIG. 9B is a schematic diagram illustrating exemplary linear variations of the clamping force according to some other embodiments of the present disclosure;

FIG. 10 is a schematic diagram illustrating an exemplary structure of an ear-clip earphone according to some embodiments of the present disclosure;

FIG. 11 is a schematic diagram illustrating exemplary first and second magnets in an ear-clip earphone according to some embodiments of the present disclosure;

FIG. 12 is a schematic diagram illustrating an exemplary non-wearing state of an ear-clip earphone according to some embodiments of the present disclosure;

FIGS. 13A and 13B are schematic diagrams illustrating exemplary variations of clamping forces provided by an ear hook, a first magnet, and a second magnet according to some embodiments of the present disclosure; and

FIG. 14 is a schematic diagram illustrating a projection of an ear-clip earphone onto a first symmetry plane according to some embodiments of the present disclosure.

### DETAILED DESCRIPTION

In order to more clearly illustrate the technical solutions of the embodiments of the present disclosure, a brief introduction will be made to the accompanying drawings used in the description of the embodiments. It is apparent that the accompanying drawings in the following description are merely some examples or embodiments of the present disclosure. For those skilled in the art, without creative effort, the present disclosure may also be applied to other similar scenarios based on these drawings. Unless obvious from the context or otherwise specified, identical reference numerals in the drawings represent identical structures or operations.

It should be understood that the terms “system”, “device”, “unit”, and/or “module” used in the present disclosure are a manner for distinguishing different components, elements, parts, portions, or assemblies of different levels. However, if other terms can achieve the same purpose, the terms may be replaced by other expressions.

As shown in the present disclosure and the claims, unless the context clearly indicates an exception, the terms “a”, “an”, “one”, and/or “the” or the like, are not specifically limited to the singular and may also include the plural. Generally, the terms “comprise” and “include” merely indicate the inclusion of explicitly identified steps and elements, and these steps and elements do not constitute an exhaustive list. A manner or a device may also comprise other steps or elements.

Flowcharts are used in the present disclosure to illustrate operations performed by a system according to embodiments of the present disclosure. It should be understood that the preceding or succeeding operations are not necessarily executed precisely in order. Instead, the steps may be processed in reverse order or simultaneously. In addition, other operations may also be added to the processes, or one or more operations may be removed from the processes.

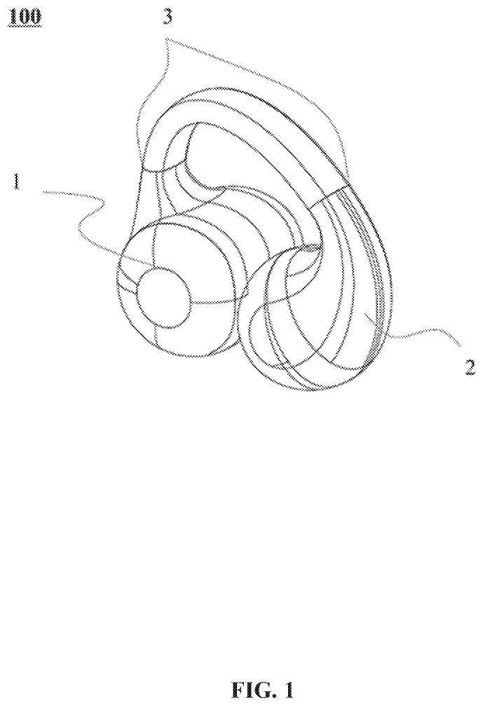

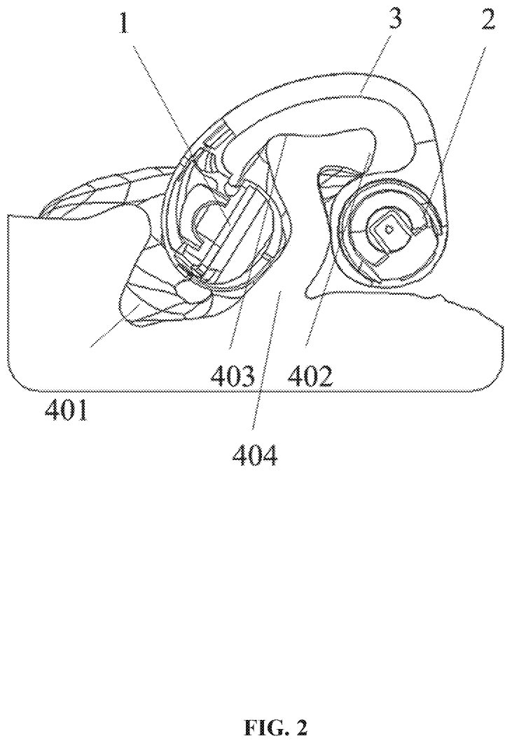

FIG. 1 is a schematic diagram illustrating an exemplary appearance structure of an ear-clip earphone according to some embodiments of the present disclosure. FIG. 2 is a schematic diagram illustrating an exemplary wearing state of an ear-clip earphone according to some embodiments of the present disclosure. The ear-clip earphone in the present disclosure may include, but is not limited to, a bone conduction earphone, an air conduction earphone, a bone-air conduction earphone, or the like. In some embodiments, the ear-clip earphone may be combined with products such as glasses, head-mounted earphones, head-mounted display devices, augmented reality/virtual reality (AR/VR) helmets, or the like.

As shown in FIGS. 1 and 2, an ear-clip earphone 100 (hereinafter referred to as the earphone 100) may include a sound-generating portion 1, an abutment portion 2, and an ear hook 3.

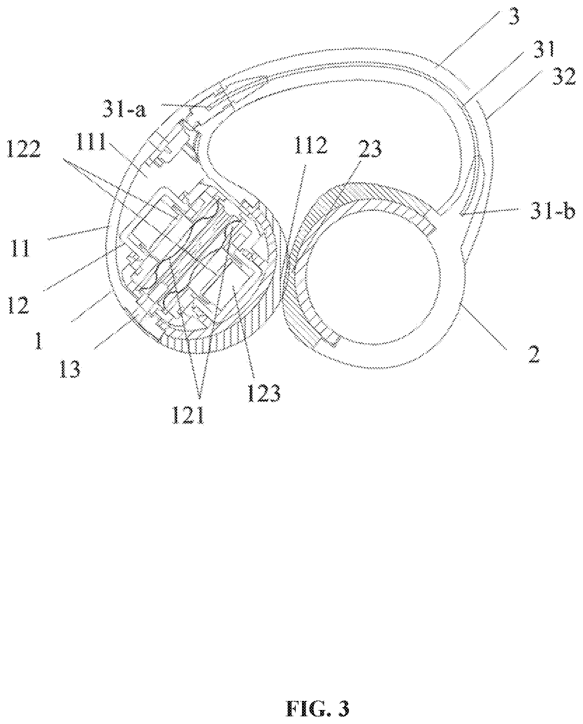

The sound-generating portion 1 is a sound playing device, which may be configured to convert an electrical signal into an audio signal and play the audio signal to a user. FIG. 3 is a schematic diagram illustrating an exemplary structure of a cross-section of an ear-clip earphone according to some embodiments of the present disclosure. As shown in FIG. 3, the sound-generating portion 1 may include a housing 11, a sound-generating assembly 12, and a sound outlet hole 13. The housing 11 may have an accommodating cavity 111 for at least accommodating the sound-generating assembly 12. The sound-generating assembly 12 can convert an electrical signal into an audio signal. For example, the sound-generating assembly 12 may include one or more loudspeakers. The sound outlet hole 13 may be located on the housing 11 and configured to guide out a sound generated by the sound-generating assembly 12.

The housing 11 may be a sphere, a cuboid, a cylinder, a frustum, an L-shape, a U-shape, a V-shape, or the like, or any irregular shape. In some embodiments, the housing may be made of plastic, metal, or other supporting materials that can be used as an earphone housing, to provide more stable support for internal components of the housing 11 (such as the sound-generating assembly 12).

The abutment portion 2 may cooperate with the sound-generating portion 1 to form a clamping device for clamping the ear-clip earphone on the helix of the user. In some embodiments, the abutment portion 2 may serve as a battery compartment for installing a battery or other components. In some embodiments, a battery may be installed in the sound-generating portion 1.

The ear hook 3 is configured to connect the sound-generating portion 1 and the abutment portion 2. As shown in FIG. 2, in a wearing state, the sound-generating portion 1 is configured to be located in a concha cavity 401 of the user and contact an inner wall of the concha cavity 401. The abutment portion 2 is configured to abut a rear side of an auricle 404 of the user, the ear hook 3 is configured to bypass an antihelix 403 and a helix 402 of the user, connect to the sound-generating portion 1 and the abutment portion 2, and provide a clamping force for clamping the sound-generating portion 1 and the abutment portion 2 on two sides of the auricle 404. As shown in FIG. 1, in a non-wearing state, the ear hook 3 provides a preload force for abutting the sound-generating portion 1 against the abutment portion 2, so that the sound-generating portion 1 and the abutment portion 2 may abut each other.

In some embodiments, as shown in FIG. 2, a region of the housing 11 abutting against the abutment portion 2 may be provided with a flexible body 112. The region abutting against the abutment portion 2 refers to a region on the housing 11 that contacts the abutment portion 2 in the non-wearing state. When the ear-clip earphone is in the wearing state, the region of the housing 11 abutting against the abutment portion 2 contacts the inner wall of the concha cavity. In some embodiments, the flexible body 112 may be made of silicone or other skin-friendly flexible materials, to improve comfort when the sound-generating portion 1 contacts the user.

In some embodiments, the ear hook 3 may be symmetrically arranged, and the ear hook 3 has a first symmetry plane S₁. In some embodiments, in the wearing state, the first symmetry plane S₁ may be parallel to a horizontal plane. In some embodiments, the first symmetry plane S₁ may be located at a midpoint position in a width direction of the ear hook 3. The first symmetry plane S₁ may divide the ear hook 3 into two mutually symmetrical portions located on two sides of the first symmetry plane S₁, along a length direction of the ear hook 3 (i.e., an extension direction from an end portion of the ear hook 3 connected to the sound-generating portion 1 to an end portion of the ear hook 3 connected to the abutment portion 2).

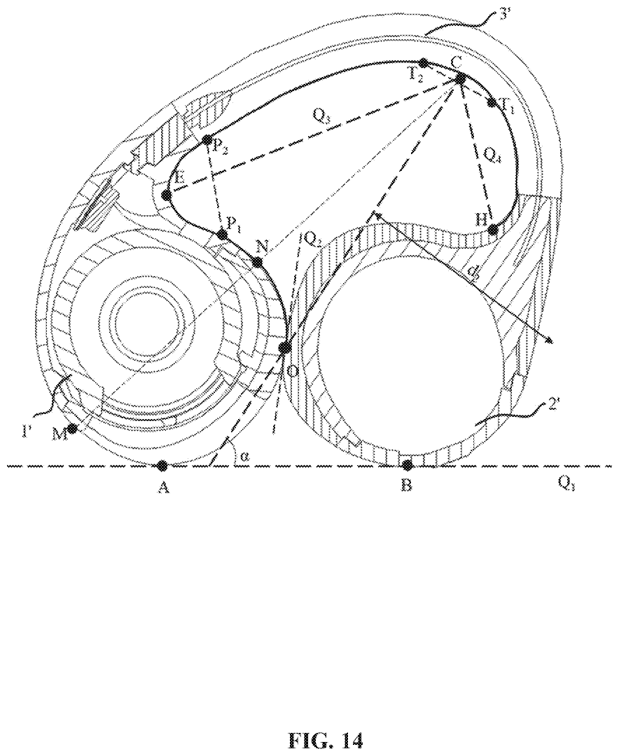

FIG. 14 is a schematic diagram illustrating a projection of an ear-clip earphone onto a first symmetry plane according to some embodiments of the present disclosure. As shown in FIG. 14, the sound-generating portion 1 forms a first projection 1′ on the first symmetry plane S₁, the abutment portion 2 forms a second projection 2′ on the first symmetry plane S₁, and the ear hook 3 forms a third projection 3′ on the first symmetry plane S₁. In some embodiments, the first projection 1′ has a lowest point A (hereinafter referred to as the point A), the second projection 2′ has a lowest point B (hereinafter referred to as the point B), and the first projection 1′ and the second projection 2′ have a common tangent line Q₁ passing through the point A and the point B. The common tangent line Q₁ is tangent to the first projection 1′ at the point A, and the tangent line Q₁ is tangent to the second projection 2′ at the point B.

For convenience of understanding, the following description takes the earphone 100 placed on a horizontal plane with the first symmetry plane S₁ perpendicular to the horizontal plane as an example. A contact point between the sound-generating portion 1 and the horizontal plane is the point A, and a contact point between the abutment portion 2 and the horizontal plane is the point B, which means that the sound-generating portion 1 is tangent to the horizontal plane at the point A, and the abutment portion 2 is tangent to the horizontal plane at the point B. At this time, the straight line Q₁ on which the point A and the point B are located in FIG. 14 may be regarded as a projection of the horizontal plane on the first symmetry plane S₁. The straight line Q₁ is simultaneously tangent to the first projection 1′ at the point A and tangent to the second projection 2′ at the point B. The first symmetry plane S₁ is parallel to a plane where the paper surface shown in FIG. 14 is located.

In some embodiments, the third projection 3′ includes an inner contour curve and an outer contour curve. The inner contour curve corresponds to a contour on one side of the ear hook 3 close to the helix in the wearing state, and the outer contour curve corresponds to a contour on the other side of the ear hook 3 away from the helix in the wearing state. On the first projection 1′, with the point A as a demarcation point, a portion connected to the inner contour curve of the third projection 3′ refers to an inner contour of the first projection 1′; and a portion connected to the outer contour curve of the third projection 3′ refers to an outer contour of the first projection 1′. On the second projection 2′, with the point B as a demarcation point, a portion connected to the inner contour curve of the third projection 3′ refers to an inner contour of the second projection 2′; and a portion connected to the outer contour curve of the third projection 3′ refers to an outer contour of the second projection 2′. In some embodiments, with the point A and the point B as boundaries, by successively connecting the inner contour of the first projection 1′, an inner contour of the third projection 3′, and the inner contour of the second projection 2′, an inner contour of the earphone 100 is jointly formed; and by successively connecting the outer contour of the first projection 1′, an outer contour of the third projection 3′, and the outer contour of the second projection 2′, an outer contour of the earphone 100 is jointly formed.

In some embodiments, the first projection l′ and the second projection 2′ have a fitting region or a fitting point therebetween, and a center point (e.g., a centroid, an area center, or the like) of the fitting region or the fitting point may serve as a first feature point O. In some embodiments, when the sound-generating portion 1 and the abutment portion 2 are in contact with each other, the inner contour of the first projection 1′ fits with the inner contour of the second projection 2′. At this time, a common tangent line Q₂ may be determined on the inner contour of the first projection 1′ and the inner contour of the second projection 2′, and the common tangent line Q₂ is simultaneously tangent to the inner contour of the first projection 1′ and the inner contour of the second projection 2′ at a first tangent point O. The first tangent point O may serve as the first feature point. In some embodiments, when a contact region between the sound-generating portion 1 and the abutment portion 2 is a surface, a centroid of a projection of the contact surface on the first symmetry plane S₁ is the first feature point O. In some embodiments, when the sound-generating portion 1 and the abutment portion 2 are a contact structure, a side of the first projection 1′ facing away from the third projection 3′ and a side of the second projection 2′ facing away from the third projection 3′ have a common tangent line (i.e., the common tangent line Q₁), a second tangent point of the common tangent line Q₁ and the first projection 1′ is the point A, a third tangent point of the common tangent line Q₁ and the second projection 2′ is the point B, and a connecting line of the point A and the point B (i.e., a connecting line AB, the straight line Q₁) may serve as a reference connecting line Q₁. In some embodiments, the first projection 1′ and the second projection 2′ have an overlapping region, and in the overlapping region, the outer contour of the first projection 1′ and the outer contour of the second projection 2′ have two intersection points, and a midpoint of a connecting line of the two intersection points serves as the first feature point O.

In some embodiments, the inner contour curve of the third projection 3′ has at least one point C farthest from the first feature point O. In some embodiments, if there are a plurality of points farthest from the first feature point O, a closest point among these farthest points to the second projection 2′ of the abutment portion 2 may serve as a second feature point C. The second feature point C may be determined by a tool, a program, or the like. For example, by inputting contour curve parameters of the earphone 100 (e.g., a simulation curve function of the inner contour of the earphone 100, a simulation curve function of the outer contour of the earphone 100, or the like) to a corresponding tool, program, or the like, information of the first feature point O may be determined, thereby outputting information (e.g., a position, or the like) of the second feature point C.

A connecting line between the first feature point O and the second feature point C is defined as a first connecting line OC. In some embodiments, a first auxiliary line Q₃ is drawn from the second feature point C toward a side biased toward the first projection 1′, a first included angle between the first auxiliary line Q₃ and the first connecting line (i.e., the connecting line OC) has a first preset value range, and an intersection point E of the inner contour curve of the third projection 3′ and the first auxiliary line Q₃ is defined as a third feature point. A connecting line CE between the third feature point E and the second feature point C is a second connecting line, and the second connecting line (i.e., the connecting line CE) is collinear with the first auxiliary line Q₃. In some embodiments, the third feature point E may serve as a demarcation point between the inner contour curve of the third projection 3′ and the inner contour of the first projection 1′. A portion of the ear hook 3 corresponding to the second connecting line CE (e.g., a portion corresponding to an arc segment CE) is disposed on a side of the second connecting line CE facing away from the abutment portion 2, so as to avoid interference between the ear hook 3 and the antihelix and the helix. In some embodiments, if the first included angle (i.e., ∠OCE) between the second connecting line CE and the first connecting line OC is too small, a portion of an inner contour of the ear hook 3 corresponding to the second connecting line CE may cause interference and extrusion with a portion from the helix to the concha cavity of an ear of the user. If the first included angle between the second connecting line CE and the first connecting line OC is too large, a dimension of the ear hook 3 may be too large, which may cause interference between the sound-generating portion 1 and a tragus of the user or block an ear canal opening of the user.

In some embodiments, to avoid the sound-generating portion 1 blocking the ear canal opening of the user and to avoid the interference between the sound-generating portion 1 and the tragus or the antihelix and the helix, the first preset value range of the first included angle may be 27°-37°, or greater than 37° and less than or equal to 50°. For example, the first included angle may be an actual value such as 27°, 33°, 37°, or the like, which is between a range of 27° to 37°, or the first included angle may also be an actual value such as 40°, 41°, 43°, 45°, or the like, which is greater than 37° and less than or equal to 50°.

In some embodiments, to avoid the sound-generating portion 1 blocking the ear canal opening of the user and to avoid the interference between the sound-generating portion 1 and the tragus or the antihelix and the helix, the first included angle between the second connecting line CE and the first connecting line may be in a range of 27° to 37°. For example, the first included angle between the second connecting line CE and the first connecting line may be 33°.

In some embodiments, a portion of the inner contour curve of the third projection 3′ corresponding to the second connecting line CE (i.e., an arc CE) has a first arc length, and a ratio between the first arc length and a length of the second connecting line CE is defined as a first arc-to-chord ratio. The first arc-to-chord ratio can reflect a degree of flatness of the arc CE corresponding to the second connecting line CE. The larger the first arc-to-chord ratio is, the greater a degree of convexity of the arc CE corresponding to the second connecting line CE is, and the larger an area within the arc CE is, the less likely a corresponding portion of the ear hook 3 is to interfere with a portion from the helix to the concha cavity of the ear. The smaller the first arc-to-chord ratio is, the flatter the arc CE corresponding to the second connecting line CE is, and the smaller an area within the arc CE is, the more likely a corresponding portion of the ear hook 3 is to interfere with a portion from the helix to the concha cavity of the ear (e.g., the helix, the antihelix). In some embodiments, the first arc-to-chord ratio may be in a range of 1.10 to 1.25. For example, the first arc-to-chord ratio may be 1.14.

In some embodiments, the first arc-to-chord ratio may be greater than 1.24 and less than or equal to 1.4. For example, the first arc-to-chord ratio may be an actual value such as 1.25, 1.29, 1.3, 1.4, or the like, which is greater than 1.24 and less than or equal to 1.4.

In some embodiments, a second auxiliary line Q₄ is drawn from the second feature point C toward a side biased toward the second projection 2′. A second included angle between the second auxiliary line Q₄ and the first connecting line OC has a second preset value range, and an intersection point H of a curve segment of the inner contour curve of the third projection 3′ connected to the second projection 2′ and the second auxiliary line Q₄ is defined as a fourth feature point. A connecting line CH between the fourth feature point H and the second feature point C is defined as a third connecting line, and the third connecting line CH is collinear with the second auxiliary line Q₄. In some embodiments, the fourth feature point H may serve as a demarcation point between the inner contour curve of the third projection 3′ and the inner contour of the third projection 3′. In some embodiments, if the second included angle (i.e., ∠OCH) between the third connecting line CH and the first connecting line OC is too small, the abutment portion 2 may excessively press against the rear side of the auricle of the user. If the second included angle between the third connecting line CH and the first connecting line OC is too large, the dimension of the ear hook 3 may be too large, and the abutment portion 2 may interfere with head skin tissue on the rear side of the auricle of the user. In some embodiments, to avoid the abutment portion 2 from excessively pressing against the ear and to avoid the abutment portion 2 from interfering with head skin of the user, the second included angle between the third connecting line CH and the first connecting line OC may be in a range of 34° to 49°. Exemplarily, the second included angle between the third connecting line CH and the first connecting line OC may be 40°. In some embodiments, to avoid the abutment portion 2 from excessively pressing against the ear and to avoid the abutment portion 2 from interfering with the head skin of the user, the second included angle between the third connecting line CH and the first connecting line OC may also be set to be greater than or equal to 20° and less than 34°. For example, the second included angle between the third connecting line CH and the first connecting line OC may be an actual value such as 20°, 25°, or 27°, that is greater than or equal to 20° and less than 34°.

In some embodiments, a portion of the inner contour curve of the third projection 3′ corresponding to the third connecting line CH (i.e., an arc CH) has a second arc length, and a ratio between the second arc length and a length of the third connecting line CH is defined as a second arc-to-chord ratio. The second arc-to-chord ratio can reflect a flatness of arc CH corresponding to the third connecting line CH. The larger the second arc-to-chord ratio, the greater an extent of protrusion of the arc CH corresponding to the third connecting line CH, the larger an area of a region within the arc CH, and the more likely the abutment portion 2 and the ear hook 3 are to abut the head skin on the rear side of the auricle. The smaller the second arc-to-chord ratio, the flatter the arc CH corresponding to the third connecting line CH, the smaller the area of the region within the arc CH, and a corresponding portion of the ear hook 3 may interfere with a portion of the ear from the helix to the rear side of the auricle (e.g., the outermost point of the helix), or the like. In some embodiments, the second arc-to-chord ratio may be in a range of 1.11 to 1.24. Exemplarily, the second arc-to-chord ratio may be 1.17. In some embodiments, the second arc-to-chord ratio may be set to be greater than 1.24 and less than or equal to 1.40. For example, the second arc-to-chord ratio may be an actual value such as 1.25, 1.26, 1.29, 1.30, or 1.40, that is greater than 1.24 and less than or equal to 1.40.

In some embodiments, a point N on the first projection 1′ closest to the second feature point C serves as a fifth feature point, and a connecting line CN between the second feature point C and the fifth feature point N serves as a fourth connecting line. An extension line of the fourth connecting line CN intersects the first projection 1′ at a sixth feature point M. In some embodiments, the sixth feature point M may be regarded as a point on the first projection 1′ farthest from the second feature point C. In some embodiments, a direction of a connecting line between the second feature point C and the sixth feature point M is roughly toward a direction of the ear canal opening of the user.

A connecting line between the fifth feature point N and the sixth feature point Mis defined as a fifth connecting line (i.e., a connecting line NM). A curve segment of the first projection 1′ corresponding to the fifth connecting line NM (i.e., an arc NM) has a third arc length, and a ratio between the third arc length (i.e., the arc NM) and a length of the fifth connecting line (i.e., the connecting line NM) is defined as a third arc-to-chord ratio. The third arc-to-chord ratio can reflect the shape of the first projection 1′, thereby reflecting the shape of the sound-generating portion 1.

In some embodiments, the third arc-to-chord ratio may be in a range of 1.4 to 1.7, so that the arc NM approximates a semicircle. The fifth connecting line NM may be regarded as a diameter of the first projection 1′, thereby making the sound-generating portion 1 spherical or approximately spherical, and making the shape of the sound-generating portion 1 adapt to the concha cavity, to improve the wearing comfort of the earphone 100. If a distance between the second feature point C and the sixth feature point M is too large, the sound-generating portion 1 may block the ear canal opening of the user or interfere with the tragus. If the distance between the second feature point C and the sixth feature point M is too small, a dimension of the sound-generating portion 1 may be affected, which may further affect an audio effect, or may cause the sound-generating portion 1 to interfere with the antihelix.

In some embodiments, the third arc-to-chord ratio may also be set to be greater than 1.7 and less than or equal to 1.8. For example, the third arc-to-chord ratio may be an actual value such as 1.75 or 1.8, that is greater than 1.7 and less than or equal to 1.8, such that the arc NM approximates a semicircle. The fifth connecting line NM may be regarded as a diameter of the first projection 1′, thereby making the sound-generating portion 1 spherical or approximately spherical, and making the shape of the sound-generating portion 1 adapt to the concha cavity, to improve the wearing comfort of the earphone 100.

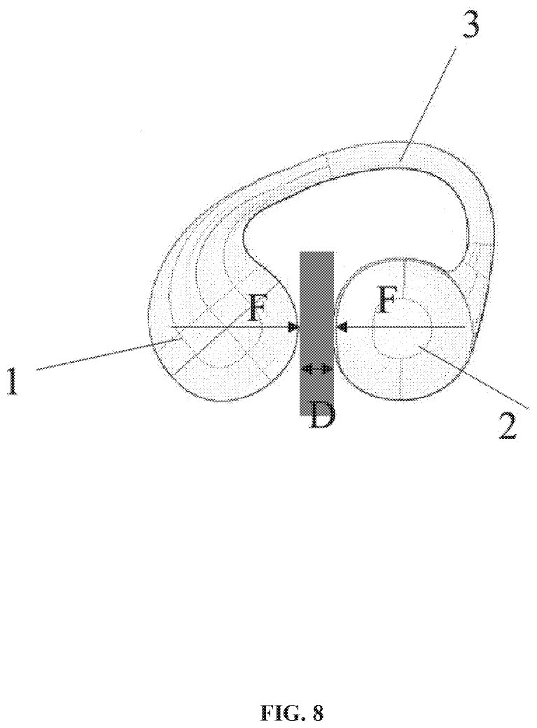

The clamping force refers to a force applied to an auricle when the sound-generating portion 1 and the abutment portion 2 clamp the auricle of the user. FIG. 8 is a schematic diagram illustrating an exemplary clamping force according to some embodiments of the present disclosure. As shown in FIG. 8, when the sound-generating portion 1 and the abutment portion 2 clamp an auricle of a user having an auricle thickness D, a force F is respectively applied to the auricle, and the force F is the clamping force. In some embodiments, the clamping force may include a deformation force F′ generated by an elastic deformation of the ear hook 3. The greater the auricle thickness D of the ear of the user, the greater the distance between the housing of the sound-generating portion 1 and the abutment portion 2, the greater the deformation of the ear hook 3 caused thereby, and the greater the corresponding deformation force F′.

In some embodiments, the clamping force may be determined by a force gauge. The manner in which the force gauge measures the clamping force is similar to a manner in which the force gauge measures a tensile force described later.

In some embodiments, in a state where the abutment portion 2 is held and the sound-generating portion 1 is freely placed such that the sound-generating portion 1 faces the ground along the gravity direction, the abutment portion 2 contacts the sound-generating portion 1. Specifically, the state where the abutment portion 2 is held and the sound-generating portion 1 is freely placed such that the sound-generating portion 1 faces the ground along the gravity direction may be understood as the ear-clip earphone 100 being suspended by holding the abutment portion 2, with the sound-generating portion 1 freely placed and facing the ground along the gravity direction. For example, it may refer to a state where the abutment portion 2 is held and the attitude of the ear-clip earphone 100 is adjusted such that the first symmetry plane S₁ is parallel to the gravity direction, and the sound-generating portion 1 is located below the abutment portion 2 along the gravity direction. In some embodiments, in the state where the abutment portion 2 is held and the sound-generating portion 1 is freely placed such that the sound-generating portion 1 faces the ground along the gravity direction, the abutment portion 2 and the sound-generating portion 1 may remain in contact under the action of the ear hook 3. For example, in the state where the abutment portion 2 is held and the sound-generating portion 1 is freely placed such that the sound-generating portion 1 faces the ground along the gravity direction, the abutment portion 2 and the sound-generating portion 1 may remain in contact under the action of a preload force and the clamping force provided by the ear hook 3.

As can be known from the foregoing, the clamping force increases with an increase in the auricle thickness of the user. It is necessary to ensure that the clamping force is greater than a lower limit value of the clamping force corresponding to a minimum auricle thickness, so that the ear-clip earphone can be stably worn on an ear of a user having a smaller auricle thickness. Further, it is necessary to ensure that the clamping force is less than an upper limit value of the clamping force corresponding to a maximum auricle thickness, so as to avoid the ear-clip earphone from causing wearing discomfort to a user having a larger auricle thickness. For example, after a plurality of experiments, it is found that when the minimum auricle thickness Dₛ is 3.5 mm, the corresponding lower limit of clamping force Fₛ is 0.20 N, which can ensure wearing stability for the minimum auricle. When the maximum auricle thickness Dₘ is 5.6 mm, the corresponding upper limit of clamping force Fₘ is 0.70 N, which can ensure wearing comfort for the maximum auricle. Therefore, in the wearing state, when the auricle thickness is in a range of 3.5 mm to 5.6 mm, the clamping force is not less than 0.20 N and not greater than 0.70 N, thereby balancing wearing stability and comfort. Further, for example, after a plurality of experiments, it is found that when the minimum auricle thickness Dₛ is 3.8 mm, the corresponding lower limit of clamping force Fₛ is 0.25 N, which can ensure wearing stability for the minimum auricle. When the maximum auricle thickness Dₘ is 5.5 mm, the corresponding upper limit of clamping force Fₘ is 0.65 N, which can ensure wearing comfort for the maximum auricle. Therefore, in the wearing state, when the auricle thickness is in a range of 3.8 mm to 5.5 mm, the clamping force is not less than 0.25 N and not greater than 0.65 N, thereby ensuring the wearing stability and comfort.

Because the clamping force may vary due to the variation of the auricle thickness, the wearing experience brought by the same ear-clip earphone to users with different auricle thicknesses may have a large difference. To avoid this problem, it is necessary to adopt a certain mechanism to reduce a difference in clamping forces of the ear-clip earphone on ears of users with different auricle thicknesses, while ensuring the wearing stability and comfort.

In some embodiments, the difference between the clamping force received by small-ear users and the clamping force received by large-ear users may be reduced by controlling an elastic coefficient of the ear hook 3. The elastic coefficient can represent a relationship between the distance between the sound-generating portion 1 and the abutment portion 2, and a deformation force provided by the ear hook 3. The greater the elastic coefficient, the greater the deformation force caused by a unit distance, which in turn leads to a greater clamping force.

Specifically, a maximum elastic coefficient km may be determined based on the minimum auricle thickness Dₛ, the maximum auricle thickness Dₘ, the lower limit of clamping force Fₛ, and the upper limit of clamping force Fₘ. In some embodiments, the elastic coefficient of the ear hook may be in a range of 0.01 N/mm to 1.6 N/mm. For example, (Fₘ−Fₛ)/(Dₘ−Dₛ)=(0.70−0.20)/(5.6−3.5)=0.5/2=1.6 N/mm. In some embodiments, the elastic coefficient of the ear hook may be in a range of 0.01 N/mm to 0.24 N/mm. For example, (Fₘ−Fₛ)/(Dₘ−Dₛ)=(0.65−0.25)/(5.5−3.8)=0.4/1.7=0.24 N/mm.

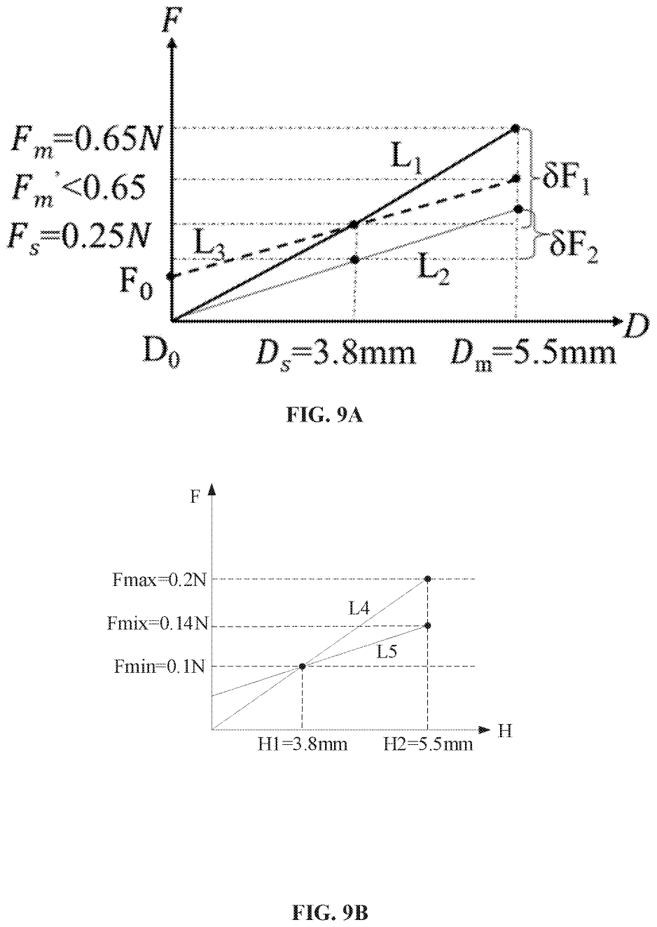

By reducing the elastic coefficient of the ear hook, the difference in clamping forces between small-ear users and large-ear users can be reduced. FIG. 9A illustrates exemplary clamping force variation curves corresponding to different elastic coefficients within a certain range according to some embodiments of the present disclosure. The clamping force variation curves can reflect the clamping force corresponding to different auricle thicknesses. L₁ is a clamping force variation curve corresponding to the ear hook with an elastic coefficient of 0.075 N/mm, and L₂ is a force variation curve corresponding to the ear hook with an elastic coefficient of 0.045 N/mm. As shown in FIG. 9A, when the elastic coefficient becomes smaller, the slope of the clamping force variation curve decreases, and the difference between the clamping force corresponding to small ears and the clamping force corresponding to large ears becomes smaller. For example, δF may represent a clamping force difference between the minimum auricle thickness Dₛ and the maximum auricle thickness Dₘ. When the elastic coefficient is reduced from 0.075 N/mm to 0.045 N/mm, the clamping force difference between the minimum auricle thickness Dₛ and the maximum auricle thickness Dₘ is reduced from δF1 to δF2.

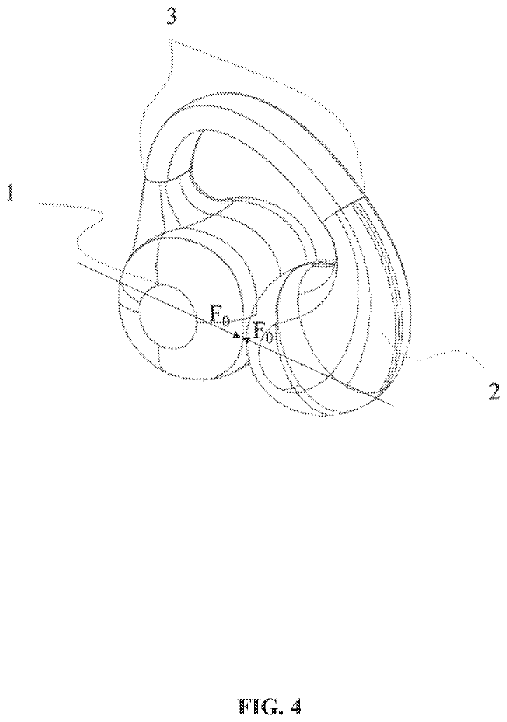

The preload force refers to a pressure pre-applied by the ear hook 3 between the sound-generating portion 1 and the abutment portion 2 in a natural state, that is, a pre-deformation force provided by a pre-deformation of the ear hook for making the sound-generating portion 1 and the abutment portion 2 abut and press each other. In the non-wearing state, the ear hook 3 does not undergo further elastic deformation, and the force applied by the ear hook 3 to the sound-generating portion 1 and the abutment portion 2 only includes the preload force. As shown in FIG. 4, in the non-wearing state, the ear hook 3 applies a preload force F₀ to the sound-generating portion 1 and the abutment portion 2, respectively, such that the sound-generating portion 1 and the abutment portion 2 abut each other. At this time, an interaction force between the sound-generating portion 1 and the abutment portion 2 is equal to the preload force F₀. In the wearing state, the ear hook 3 further undergoes elastic deformation, and the force applied by the ear hook 3 to the sound-generating portion 1 and the abutment portion 2 includes an elastic deformation force and the preload force. That is, the clamping force mentioned above includes the elastic deformation force and the preload force.

In some embodiments, a structure of the ear hook 3 (such as a shape or included components) may be designed to enable it to provide the preload force, thereby ensuring wearing stability of small ears. For example, a titanium sheet may be disposed in the ear hook 3 to enable the ear hook 3 to provide the preload force. For example, the preload force may be in a range of 0.01 N to 0.20 N. As another example, the preload force may be in a range of 0.01 N to 0.25 N. Merely by way of example, the preload force may be 0.08 N.

In some embodiments, the preload force may compensate for a reduction in the clamping force caused by a reduction in the elastic coefficient. As can be known from the foregoing, to reduce the clamping force difference corresponding to the minimum auricle thickness and the maximum auricle thickness, the elastic coefficient may be reduced; however, reducing the elastic coefficient may reduce the clamping force and affect wearing stability. As shown in FIG. 9A, when the clamping force is only provided by the deformation force, on a line L₂ after the elastic coefficient is reduced, the clamping force corresponding to the minimum auricle thickness Dₛ is less than the lower limit Fₛ of the clamping force, which leads to the ear-clip earphone being unable to be stably worn on the ears of small-ear users. In some embodiments of the present disclosure, by applying the preload force to the sound-generating portion 1 and the abutment portion 2 by the ear hook 3, the wearing stability when the elastic coefficient becomes small is improved.

Specifically, in a critical state, the preload force provides all of the clamping force, and therefore, a maximum value of the preload force F₀ is the lower limit Fₛ of the clamping force corresponding to the minimum auricle thickness Dₛ.

For example, as shown in FIG. 9A, after the ear hook is configured to apply the preload force F₀, the clamping force change curve changes from the line L₂ to a line L₃. At this time, the clamping force corresponding to the minimum auricle thickness Dₛ is 0.25 N, which can ensure the wearing stability for small-ear users; the clamping force corresponding to the maximum auricle thickness Dₘ becomes Fₘ′, which is less than 0.65 N; and the difference in clamping forces between the minimum auricle thickness Dₛ and the maximum auricle thickness Dₘ is maintained at δF₂. It can be clearly seen from FIG. 9A that, by applying the preload force, the difference between the clamping force received by small-ear users and the clamping force received by large-ear users may be less than δF₁, δF₁ is a difference between Fₘ and Fₛ, and is equal to 0.40 N.

As another example, when the clamping force variation curve is gentler, the clamping force corresponding to the minimum auricle thickness Dₛ is 0.25 N, which can ensure the wearing stability for small-ear users; the clamping force corresponding to the maximum auricle thickness Dₘ becomes Fₘ″, which is less than 0.45 N; and the difference in clamping forces between the minimum auricle thickness Dₛ and the maximum auricle thickness Dₘ is maintained at δF₃. That is, when the distance between the housing of the sound-generating portion 1 and the abutment portion 2 varies between Dₛ (3.8 mm) and Dₘ (5.5 mm), a variation of the clamping force does not exceed 0.20 N.

It should be noted that the clamping force change curves shown in FIG. 9A are merely for illustrative purposes, and are not intended to limit the scope of the present disclosure. For example, a relationship between the auricle thickness and the clamping force may be nonlinear.

In some embodiments, the preload force may be measured by a film pressure sensor. Specifically, the film pressure sensor is placed between the sound-generating portion 1 and the abutment portion 2, such that the film pressure sensor is subjected to the pressure from the sound-generating portion 1 and the abutment portion 2, thereby measuring the preload force.

In some embodiments, the preload force may be measured by applying a pulling force to the sound-generating portion 1 and/or the abutment portion 2. Specifically, the pulling force in a direction opposite to the preload force received by the sound-generating portion 1 and/or the abutment portion 2 may be applied multiple times to the sound-generating portion 1 and/or the abutment portion 2. Each time the pulling force is applied, the sound-generating portion 1 and the abutment portion 2 are pulled apart by a certain distance. Based on the pulling force applied multiple times and the corresponding distances, the preload force between the sound-generating portion 1 and the abutment portion 2 may be determined.

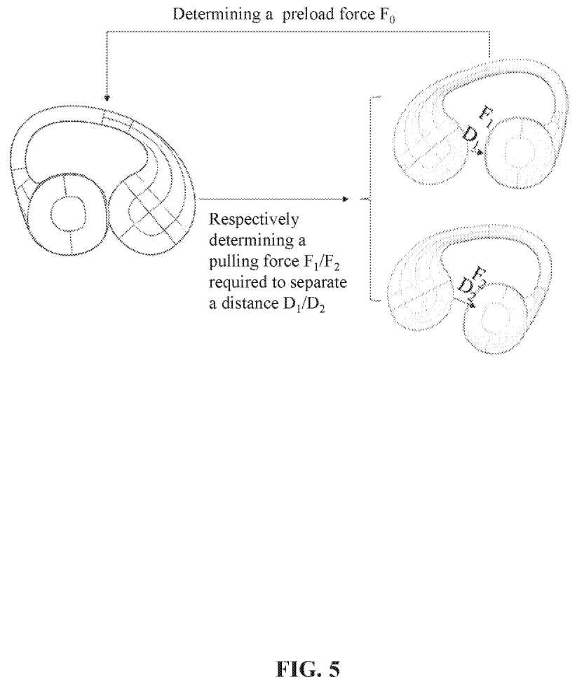

For example, FIG. 5 is a schematic diagram illustrating an exemplary process for obtaining a preload force according to some embodiments of the present disclosure. As shown in FIG. 5, when a pulling force F₁ is applied to the sound-generating portion 1 or the abutment portion 2, a distance between the sound-generating portion 1 and the abutment portion 2 is D₁; when a pulling force F₂ is applied to the sound-generating portion 1 or the abutment portion 2, a distance between the sound-generating portion 1 and the abutment portion 2 is D₂; based on D₁, F₁, D₂, and F₂, the preload force F₀ may be determined.

In some embodiments, the pulling force applied to the sound-generating portion 1 and/or the abutment portion 2 may be determined by a force gauge. The force gauge may include, but is not limited to, a digital force gauge (such as a digital push-pull force gauge), a mechanical force gauge (such as a spring force gauge), or the like. In some embodiments, the distance between the sound-generating portion 1 and the abutment portion 2 may be determined by a distance measuring instrument. The distance measuring instrument may include, but is not limited to, a vernier caliper, a laser distance meter, or the like.

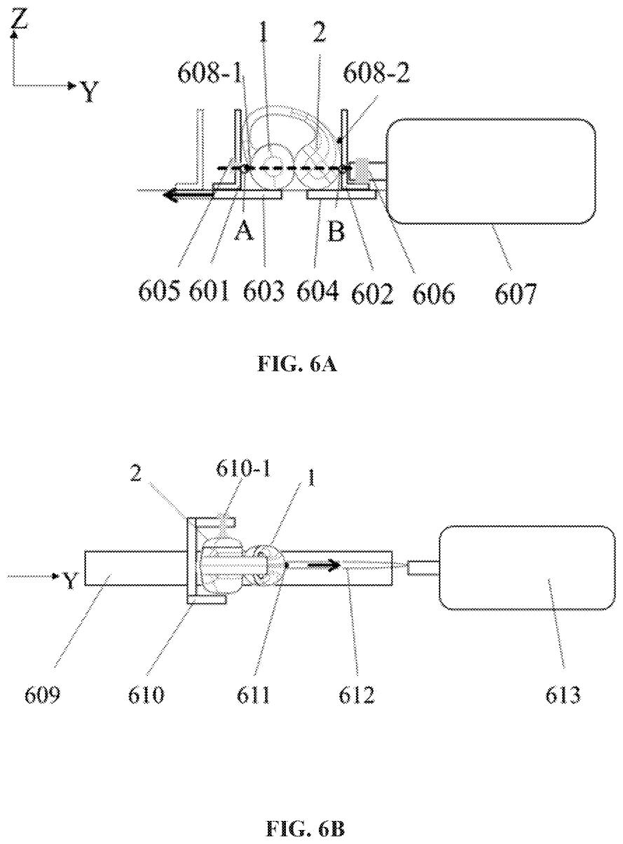

FIGS. 6A and 6B are schematic diagrams illustrating an exemplary process for determining two pulling forces and two corresponding distances according to some embodiments of the present disclosure. Merely by way of example, as shown in FIG. 6A, by means of the adhesive (e.g., a quick-drying glue, a hot melt adhesive, or the like) or other fixing manners that do not damage the structure of the ear-clip earphone (hereinafter referred to as the earphone), an auxiliary plate 603 and an angle code 601 are fixed in a Y direction, an auxiliary plate 604 and an angle code 602 are fixed in the Y direction, and the auxiliary plate 603 and the auxiliary plate 604 are placed on a support table having a small friction coefficient in the Y direction (e.g., a lubricating oil interface or a support table on a bearing support). An inner side of the angle code 601 in a Z direction and an inner side of the angle code 602 in the Z direction are respectively tangent to two sides of the earphone, thereby fixing the earphone between the angle code 601 and the angle code 602. A screw 605 passes through the angle code 601 to fasten the sound-generating portion 1 in the Y direction of the angle code 601, and a nut 606 connects a force gauge 607 in the Y direction to the angle code 602. In some embodiments, the earphone may be further fixed by the adhesive (e.g., the quick-drying glue, the hot melt adhesive, or the like) or other fixing manners that do not damage the structure of the ear-clip earphone, such that connecting points of the earphone and the two angle codes are close to a horizontal direction. For example, as shown in FIG. 6A, an outer side of the sound-generating portion 1 is fixed at a point 608-1, an outer side of the abutment portion 2 is fixed at a point 608-2, such that a connecting line between a connecting point A and a connecting point B is parallel to the Y direction. The connecting point A connects a side of the sound-generating portion 1 and the angle code 601. The connecting point B connects a side of the abutment portion 2 and the angle code 602. During measurement, the auxiliary plate 604 is fixed, the auxiliary plate 603 is moved by the pulling force in the Y direction, such that the sound-generating portion 1 and the abutment portion 2 are pulled apart by a distance, and the magnitude of the pulling force is obtained by the force gauge 607, and a distance between the auxiliary plate 603 and the auxiliary plate 604 is obtained by a vernier caliper, which is the distance by which the sound-generating portion 1 and the abutment portion 2 are pulled apart.

As another example, as shown in FIG. 6B, a clamping device 610 fixes the abutment portion 2 by a fastener 610-1, and connects one end of a force measuring line 612 to the housing on a side of the sound-generating portion 1 away from the battery compartment by the adhesive (e.g., the quick-drying glue, the hot melt adhesive, or the like) (e.g., a measuring device is at a maximum cross-section 611 parallel to the horizontal plane), and connects the other end of the force measuring line 612 to a force gauge 614. The force measuring line 612 is parallel to the Y direction. During measurement, a force gauge 613 is fixed, the force gauge 614 is moved by the pulling force in the Y direction, thereby pulling the sound-generating portion 1 to move, such that the sound-generating portion 1 and the abutment portion 2 are pulled apart by a distance, and the distance by which the sound-generating portion 1 and the abutment portion 2 are pulled apart is obtained by a vernier caliper 609, and the magnitude of the pulling force is obtained by the force gauge 607.

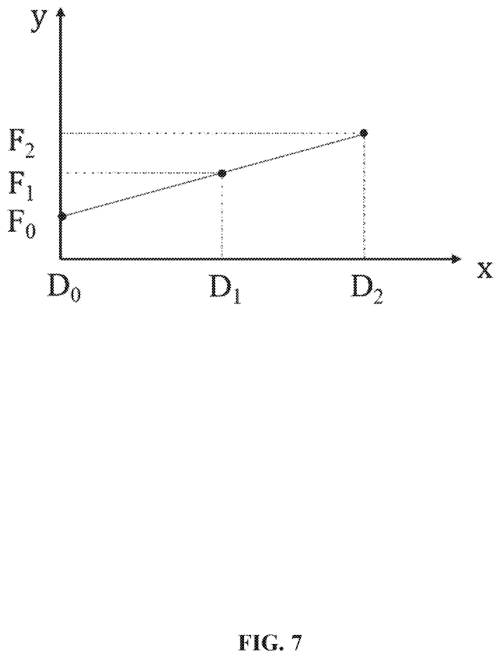

In some embodiments, a relationship line between the pulling force and the distance may be obtained by data fitting based on the pulling force and a corresponding distance, and the preload force between the sound-generating portion 1 and the abutment portion 2 corresponding to a state where the sound-generating portion 1 and the abutment portion 2 abut each other (that is, the distance between the sound-generating portion and the abutment portion is 0 mm) may be determined based on the relationship line between the pulling force and the distance. FIG. 7 is a schematic diagram illustrating an exemplary process for fitting a preload force based on two pulling forces and two corresponding distances according to some embodiments of the present disclosure. As shown in FIG. 7, based on F₁, F₂, D₁, and D₂, a relationship line y=kx+F₀ is obtained by data fitting, and an intersection point of the relationship line and a Y-axis is the preload force F₀, that is, when the distance between the sound-generating portion 1 and the abutment portion 2 is 0 mm, a mutual force in an abutment direction is determined as the preload force F₀.

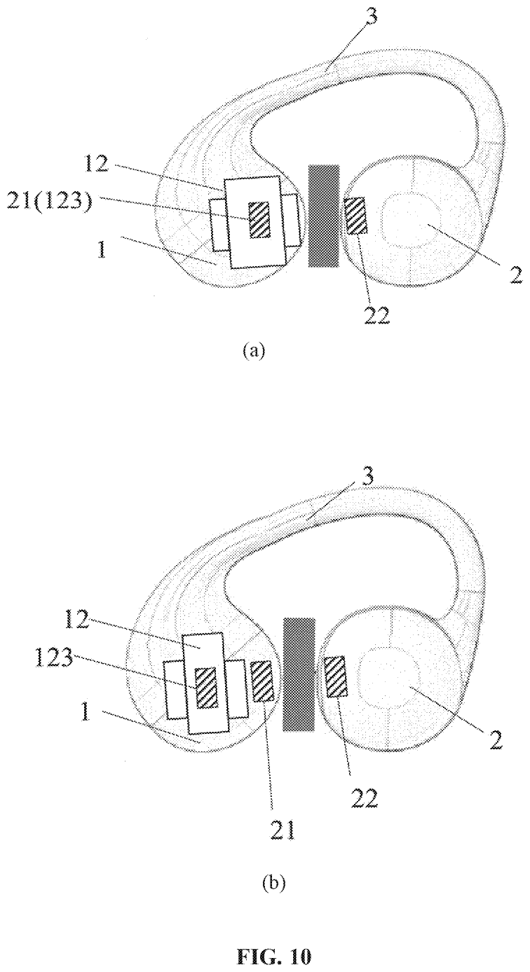

In some embodiments, a first magnet may be disposed in the sound-generating portion 1, a second magnet may be disposed in the abutment portion 2, and the first magnet and the second magnet attract each other to compensate the clamping force provided by the sound-generating portion 1 and the abutment portion 2. Detailed descriptions regarding the attraction force of the first magnet and the second magnet for compensating the clamping force may be referred to FIG. 10 and related descriptions thereof.

In some embodiments, the ear hook 3 may include an elastic material such as metal, alloy, or the like. In some embodiments, the elastic material may be a linear structure, a strip-shaped structure, etc., having a length. Merely by way of example, the ear hook 3 may include a titanium sheet.

For example, as shown in FIG. 3, the ear hook 3 may include a titanium sheet 31 and a flexible layer 32 wrapping an outer side of the titanium sheet. Two end portions 31-a and 31-b of the titanium sheet 31 in a length direction are respectively connected to the housing 11 and the abutment portion 2. Compared with a titanium wire, using the titanium sheet as the elastic material of the ear hook 3 can reduce torque at the two ends of the titanium sheet, so that the relationship between the clamping force and the distance between the housing 11 of the sound-generating portion 1 and the abutment portion 2 can approximate a linear relationship.

In some embodiments, a dimension of the titanium sheet in a width direction may be in a range of 1.5 mm to 3 mm, and a dimension of the titanium sheet in a thickness direction may be in a range of 0.15 mm to 0.3 mm. In some embodiments, the elastic coefficient of the ear hook is determined based on the Young's modulus, flexural rigidity, thickness, length, and width of the elastic material in the ear hook 3. Specifically, based on an external dimension of the ear hook 3, the thickness h and the length L of the titanium sheet are determined, and further, based on the Young's modulus and flexural rigidity of titanium and an elastic coefficient range of the ear hook, the dimensions of the titanium sheet in the width direction and the thickness direction may be determined.

In some embodiments of the present disclosure, the ear hook 3 provides the preload force for the housing 111 of the sound-generating portion 1 and the abutment portion 2, which may ensure that when the difference in clamping forces received by small-ear users and large-ear users is reduced by decreasing the elastic coefficient of the ear hook 3, the clamping force received by small ears may remain unchanged, thereby improving the stability and comfort for users with auricles of different thicknesses.

As shown in FIG. 14, the second feature point C is a protruding point of the ear hook 3, and the stress at the second feature point C of the ear hook 3 is relatively large. To avoid excessive stress concentration on the ear hook 3 and improve the service life of the ear hook 3, the degree of protrusion of the third projection 3′ near the second feature point C should not be excessively large. However, if the degree of protrusion of the third projection 3′ near the second feature point C is too small, it may affect the overall structure and dimension of the earphone 100, and may cause the ear hook 3 to interfere with the user's ear, thereby affecting the wearing stability of the earphone 100.

In some embodiments, to characterize the degree of protrusion of the ear hook 3 near the second feature point C, two arc segments (e.g., an arc CT1 and an arc CT2) with equal arc lengths may be respectively determined on the inner contour curve of the third projection 3′, centered at the second feature point C, on two sides of the second feature point C. A connecting line between ends of the two arc segments (e.g., the arc CT1 and the arc CT2) away from the second feature point C is defined as a connecting line T1T2, and an arc segment corresponding to the connecting line T1T2 is an arc T1T2. An arc-to-chord ratio between an arc length of the arc T1T2 and a length of the connecting line T1T2 may represent a corresponding degree of curvature of the arc T1T2, thereby representing the degree of protrusion of the inner contour curve at a position corresponding to the arc T1T2.

In some embodiments, to accurately characterize the degree of protrusion of the ear hook 3 near the second feature point C, points T1 and T2 should not be excessively close to or excessively far from the second feature point C. In some embodiments, the arc lengths of the arc CT1 and the arc CT2 may be in a range of 2.5 mm to 3.5 mm. In some embodiments, to further improve the accuracy of the characterization of the degree of protrusion of the ear hook 3 near the second feature point C, a preset arc length range may be 2.7 mm-3.2 mm.

In some embodiments, when the sound-generating portion 1 and the abutment portion 2 are not in contact with each other, to avoid excessive stress concentration of the ear hook 3 and simultaneously ensure the wearing stability of the earphone 100, the arc-to-chord ratio between the arc length of the arc T1T2 and the length of the connecting line T1T2 may be in a range of 1.00 to 1.10. In some embodiments, to further avoid excessive stress concentration of the ear hook 3 and extend the service life of the ear hook 3, the arc-to-chord ratio between the arc length of the arc T1T2 and the length of the connecting line T1T2 may be in a range of 1.01 to 1.07. Exemplarily, the arc-to-chord ratio between the arc length of the arc T1T2 and the length of the connecting line T1T2 may be 1.04.

In some embodiments, when the sound-generating portion 1 and the abutment portion 2 abut each other, the arc-to-chord ratio between the arc length of the arc T1T2 and the length of the connecting line T1T2 may be in a range of 1.03 to 1.12. Exemplarily, the arc-to-chord ratio between the arc length of the arc T1T2 and the length of the connecting line T1T2 may be 1.06.

FIG. 10 is a schematic diagram illustrating an exemplary structure of an ear-clip earphone according to some embodiments of the present disclosure.

The ear-clip earphone shown in (a) and (b) of FIG. 10 is similar to the ear-clip earphone shown in FIG. 1 and also includes the sound-generating portion 1, the abutment portion 2, and the ear hook 3. In the ear-clip earphone shown in (a) and (b) of FIG. 10, a first magnet 21 is disposed in the sound-generating portion 1, and a second magnet 22 is disposed in the abutment portion 2. The first magnet 21 and the second magnet 22 attract each other to compensate the clamping force provided by the ear hook 3 for the sound-generating portion 1 and the abutment portion 2. Compensating the clamping force provided by the ear hook 3 for the sound-generating portion 1 and the abutment portion 2 may be understood as that a portion of the clamping force provided by the ear hook 3 is formed due to the mutual attraction between the first magnet 21 and the second magnet 22. The first magnet 21 and the second magnet 22 are respectively disposed on an inner side of a region where the sound-generating portion 1 and the abutment portion 2 abut each other. In some embodiments, a region of the housing abutting the abutment portion and a region of the abutment portion abutting the housing are each provided with a flexible body. Referring to FIG. 3, the housing 11 and the abutment portion 2 abut each other, a region on the housing 11 that abuts the abutment portion 2 is provided with a flexible body 112, and a region on the abutment portion 2 that abuts the housing 11 is provided with a flexible body 23. The first magnet 21 is embedded in the flexible body 112 of the housing 11, and the second magnet 22 is embedded in the flexible body 23 of the abutment portion 2, such that a distance between the first magnet and the second magnet may be shortened. Therefore, the magnitude and direction of the attraction force are more in line with an ideal state. Meanwhile, the flexible bodies cover the first magnet and the second magnet, and will not affect the wearing comfort.

In some embodiments, the first magnet and/or the second magnet may include a Halbach magnet array composed of a plurality of magnets. For example, the plurality of magnets may be arranged along a length direction of the first magnet and/or the second magnet. Magnetic attraction force directions of the plurality of magnets may be different, so that the magnetic attraction force of the first magnet and/or the second magnet, generated by superimposing the magnetic attraction forces of the plurality of magnets, may be weakened or strengthened in different directions. For example, the magnetic attraction force on a side of a magnet away from the abutment region may be weakened, and the magnetic attraction force on a side of a magnet near the abutment region may be strengthened, so that the same magnitude of the magnetic attraction force can be achieved with a smaller amount of magnet material, thereby enabling the ear-clip earphone to have a more compact structure and a lighter weight, and improving the wearing comfort.

In some embodiments, the first magnet 21 is a part of the sound-generating assembly 12. As shown in (a) of FIG. 10, a magnet 123 of the sound-generating assembly 12 may serve as the first magnet 21. Referring to FIG. 3, the sound-generating assembly 12 may be accommodated in the accommodating cavity 111 of the sound-generating portion 1, and further includes a diaphragm 121 and a voice coil 122. The voice coil 122 may be connected to the diaphragm 121. The voice coil 122 is located in the magnetic field of the magnet 123. In an energized state, the voice coil 122 may drive the diaphragm 121 to vibrate. The magnet 123 is disposed relative to the diaphragm 121 on a side of the sound-generating assembly 12 near the concha cavity.

In some embodiments, the first magnet 21 and the sound-generating assembly 12 are independent of each other. As shown in (b) of FIG. 10, the first magnet 21 is located outside the sound-generating assembly 12. The sound-generating assembly 12 includes the magnet 123 (which may also be referred to as a third magnet). The first magnet 21 is closer to the second magnet 22 than the magnet 123.

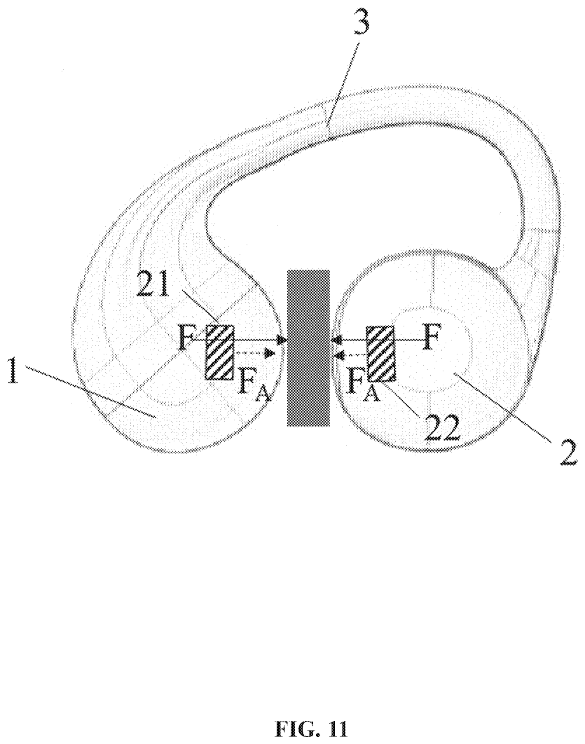

In the wearing state, the attraction force between the first magnet 21 and the second magnet 22 may compensate the clamping force provided by the ear hook 3 for the sound-generating portion 1 and the abutment portion 2. As shown in FIG. 11, the first magnet 21 and the second magnet 22 may attract each other to generate an attraction force F_{A}, thereby compensating the clamping force F provided by the ear hook 3 for the sound-generating portion and the abutment portion. That is, in the wearing state, the clamping force F includes the attraction force F_{A} and a deformation force F′ generated by the ear hook 3 due to the elastic deformation. In some embodiments, the relationship between the distance and the attraction force between the first magnet 21 and the second magnet 22 may be expressed by Formula (1):

$${F}_{A} = K \frac{{m}_{1} * {m}_{2}}{{d}^{2}} = K \frac{{m}_{1} * {m}_{2}}{{( x + {x}_{0} )}^{2}} , \qquad ( 1 )$$

where K is a constant; m₁ denotes a magnetic moment of the first magnet 21; m₂ denotes a magnetic moment of the second magnet 22; d denotes the distance between the first magnet 21 and the second magnet 22; x₀ denotes the distance between the first magnet 21 and the second magnet 22 in the non-wearing state; and x denotes an increased distance between the first magnet 21 and the second magnet 22 due to movement of the sound-generating portion and the abutment portion in the wearing state.

It can be known from Formula (1) that, the greater the increase in the increased distance x between the sound-generating portion 1 and the abutment portion 2, the greater the distance d between the first magnet 21 and the second magnet 22 accordingly, and the attraction force F_{A} between the first magnet 21 and the second magnet 22 decreases accordingly.

In some embodiments, a force gauge and pad materials of different thicknesses (e.g., silicone pads, thick paper sheets, rubber pads, or the like) may be used to measure different attraction forces corresponding to different distances between the first magnet 21 and the second magnet 22. Specifically, the ear hook 3 of the ear-clip earphone may be cut off. Then, one of the sound-generating portion 1 and the abutment portion 2 may be fixed, and the other one of the sound-generating portion 1 and the abutment portion 2 may be connected to the force gauge. The sound-generating portion 1, the abutment portion 2, and the force gauge are configured to be arranged side by side in a Y direction, similar to FIG. 6. The pad materials of different thicknesses may be placed between the sound-generating portion 1 and the abutment portion 2 to control the distance between the first magnet 21 and the second magnet 22. Meanwhile, the attraction force between the first magnet 21 and the second magnet 22 when placing the pad materials of different thicknesses may be measured by the force gauge. In some embodiments, the attraction force may be measured by a film pressure sensor. Specifically, after cutting off the ear hook 3 of the ear-clip earphone, the film pressure sensor and the pad materials of different thicknesses may be placed between the sound-generating portion 1 and the abutment portion 2, such that the film pressure sensor is pressed by the attraction force of the first magnet 21 in the sound-generating portion 1 and the second magnet 22 in the abutment portion 2, thereby measuring the attraction force corresponding to different distances between the first magnet 21 and the second magnet 22.

In some embodiments, in the non-wearing state, the ear hook 3 may provide a preload force to make the sound-generating portion 1 and the abutment portion 2 abut each other. Detailed descriptions regarding the preload force may be found in FIG. 1 and related descriptions thereof, which will not be repeated herein.

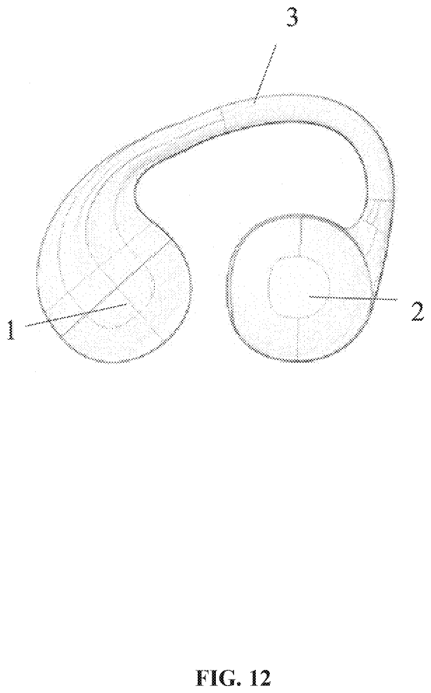

In some embodiments, in the non-wearing state, the sound-generating portion 1 and the abutment portion 2 are not in contact with each other. As shown in FIG. 12, in the non-wearing state, the sound-generating portion 1 and the abutment portion 2 are not in contact with each other. That is, there is no preload force between the sound-generating portion 1 and the abutment portion 2 to make them abut each other.

In some embodiments, in the wearing state, the clamping force provided by the ear hook 3 for the sound-generating portion 1 and the abutment portion 2 may include the deformation force generated by the ear hook 3 due to the elastic deformation and the attraction force between the first magnet 21 and the second magnet 22. In some embodiments, the clamping force may also include the preload force provided by the ear hook 3 for the sound-generating portion 1 and the abutment portion 2 to abut each other.

In some embodiments, the clamping force provided by the ear hook, the first magnet, and the second magnet may be determined by the force gauge. Detailed descriptions regarding measuring the clamping force by the force gauge may be found in FIG. 1 and related descriptions thereof.

From the foregoing, it can be seen that, to ensure the stability of the ear-clip earphone when worn on the user's ear, the clamping force provided by the ear hook 3 (i.e., a sum of the deformation force and the attraction force, or a sum of the deformation force, the attraction force, and the preload force) needs to be greater than a lower limit of the clamping force corresponding to the minimum auricle thickness; and it also needs to be ensured that the clamping force is less than an upper limit of the clamping force corresponding to the maximum auricle thickness, so as to avoid the ear-clip earphone from causing wearing discomfort to a user having a relatively large auricle thickness. In some embodiments, when the distance between the housing of the sound-generating portion 1 and the abutment portion 2 is in a range of 3.5 mm to 5.6 mm, the clamping force provided by the ear hook 3 (i.e., the sum of the deformation force and the attraction force, or the sum of the deformation force, the attraction force, and the preload force) may be in a range of 0.20 N to 0.70 N. For example, the clamping force provided by the ear hook 3 (i.e., the sum of the deformation force and the attraction force, or the sum of the deformation force, the attraction force, and the preload force) may be determined to be in a range of 0.20 N to 0.70 N, based on the lower limit of the clamping force corresponding to the minimum auricle thickness, which is 0.20 N, and the upper limit of the clamping force corresponding to the maximum auricle thickness, which is 0.70 N. In some embodiments, when the distance between the housing of the sound-generating portion 1 and the abutment portion 2 is in a range of 3.8 mm to 5.5 mm, the clamping force provided by the ear hook 3 (i.e., the sum of the deformation force and the attraction force, or the sum of the deformation force, the attraction force, and the preload force) may be in a range of 0.25 N to 0.65 N. For example, the clamping force provided by the ear hook 3 (i.e., the sum of the deformation force and the attraction force, or the sum of the deformation force, the attraction force, and the preload force) may be determined to be in a range of 0.25 N to 0.65 N, based on the lower limit of the clamping force corresponding to the minimum auricle thickness, which is 0.25 N, and the upper limit of the clamping force corresponding to the maximum auricle thickness, which is 0.65 N.

From the foregoing, it can be seen that, to ensure the stability of the ear-clip earphone when worn on the user's ear, the clamping force provided by the ear hook 3 (i.e., the sum of the deformation force and the attraction force, or the sum of the deformation force, the attraction force, and the preload force) needs to be greater than the lower limit of the clamping force corresponding to the minimum auricle thickness; and it also needs to be ensured that the clamping force is less than the upper limit of the clamping force corresponding to the maximum auricle thickness, so as to avoid the ear-clip earphone from causing wearing discomfort to a user having a relatively large auricle thickness. As shown in FIG. 9B, in some embodiments, a variation curvature of the clamping force (i.e., the sum of the deformation force and the attraction force, or the sum of the deformation force, the attraction force, and the preload force) with respect to a distance H (the distance H also refers to the distance between the housing of the sound-generating portion 1 and the abutment portion 2) may refer to a curve L4 and a curve L5, wherein Fmax is an upper limit value of the clamping force (i.e., the sum of the deformation force and the attraction force, or the sum of the deformation force, the attraction force, and the preload force) when the clamping force varies with the distance H between 3.8 mm and 5.5 mm, according to a variation pattern of the curve L4, and Fmin is a lower limit value of the clamping force (i.e., the sum of the deformation force and the attraction force, or the sum of the deformation force, the attraction force, and the preload force) when the clamping force varies with the distance H between 3.8 mm and 5.5 mm, according to a variation pattern of the curve L4 or the curve L5. Fmix is an upper limit value of the clamping force (i.e., the sum of the deformation force and the attraction force, or the sum of the deformation force, the attraction force, and the preload force) when the clamping force varies with the distance H between 3.8 mm and 5.5 mm, according to a variation pattern of the curve L5. When the distance between the housing of the sound-generating portion 1 and the abutment portion 2 varies between H1 (3.8 mm) and H2 (5.5 mm), the clamping force provided by the ear hook 3 (i.e., the sum of the deformation force and the attraction force, or the sum of the deformation force, the attraction force, and the preload force) may be in a range of Fmin (0.10 N) to Fmax (0.20 N). For example, the clamping force may be an actual value, such as Fmin (0.10 N), 0.15 N, Fmax (0.20 N), or the like, which is in the range of Fmin (0.10 N) to Fmax (0.20 N). For example, when the distance between the housing of the sound-generating portion 1 and the abutment portion 2 is H1 (3.8 mm), the clamping force is set to Fmin (0.1 N), and when the distance between the housing of the sound-generating portion 1 and the abutment portion 2 is H2 (5.0 mm), the clamping force is set in a range of Fmix (0.14 N) to Fmax (0.2 N). For example, the clamping force may be set to an actual value, such as Fmix (0.14 N), 0.15 N, Fmax (0.2 N), or the like, which is in the range of Fmix (0.14 N) to Fmax (0.2 N).

As shown in FIG. 9B, in some embodiments, when the distance between the housing of the sound-generating portion 1 and the abutment portion 2 is 5 mm, the clamping force provided by the ear hook 3 (i.e., the sum of the deformation force and the attraction force, or the sum of the deformation force, the attraction force, and the preload force) is in a range of 0.14 N to 0.20 N. For example, the clamping force may be an actual value, such as 0.14 N, 0.15 N, or 0.2 N, which is in the range of 0.14 N to 0.20 N.

From the foregoing, it can be seen that, the greater the distance x between the sound-generating portion 1 and the abutment portion 2, the greater the deformation force Fₖ provided by the ear hook 3, and the smaller the attraction force F_{A} between the first magnet 21 and the second magnet 22. Therefore, based on the attraction force between the first magnet 21 and the second magnet 22, the difference between the clamping force received by the small-ear user and the clamping force received by the large-ear user may be further reduced. For example, by limiting the clamping force to be in a range of 0.3 N to 0.5 N, the difference between the clamping force received by the small-ear user and the clamping force received by the large-ear user is simultaneously narrowed to 0.20 N. In some embodiments, when the distance between the housing of the sound-generating portion 1 and the abutment portion 2 varies between 3.8 mm and 5.5 mm, the variation of the clamping force provided by the ear hook 3 does not exceed 0.20 N. From the foregoing, it can be seen that, to ensure that the difference between the clamping force received by the small-ear user and the clamping force received by the large-ear user is relatively small, based on the minimum auricle thickness Dₛ, the lower limit Fₛ of the clamping force, the maximum auricle thickness Dₘ, and the upper limit Fₘ of the clamping force, the variation of the clamping force is limited not to exceed 0.20 N (i.e., a difference between Fₘ and Fₛ) when the distance between the housing of the sound-generating portion 1 and the abutment portion 2 varies between 3.8 mm and 5.5 mm.

In some embodiments, when the distance between the housing of the sound-generating portion 1 and the abutment portion 2 varies between 3.8 mm and 5.5 mm, a variation of the attraction force, with which the first magnet 21 and the second magnet 22 attract each other, may be in a range of 0.05 N to 0.10 N.

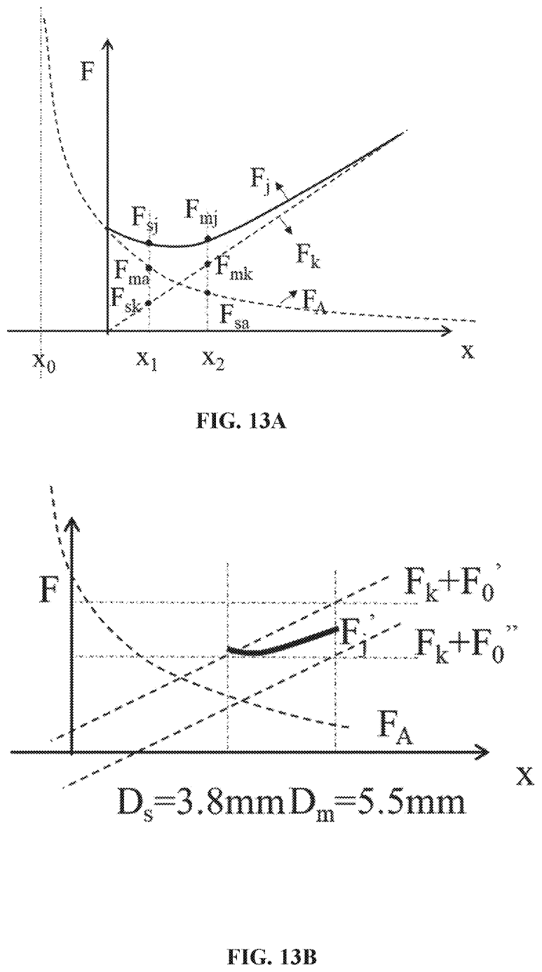

FIGS. 13A and 13B are schematic diagrams illustrating exemplary variations of clamping forces provided by an ear hook, a first magnet, and a second magnet according to some embodiments of the present disclosure. As shown in FIG. 13A, a clamping force Fⱼ provided by the ear hook includes a deformation force Fₖ and an attraction force F_{A}. An initial distance between the first magnet and the second magnet is x₀. The deformation force Fₖ is equal to kx, where k is a spring coefficient, and x is the distance between the sound-generating portion and the abutment portion. The attraction force F_{A} may be determined based on the formula (1) described above. When the distance between the housing of the sound-generating portion and the abutment portion is in a range of x₁ to x₂, the deformation force Fₖ provided by the ear hook is in a range of Fₛₖ to Fₘₖ, the attraction force F_{A} provided by the first magnet and the second magnet is in a range of Fₘₐ to Fₛₐ, and the clamping force Fⱼ is in a range of Fₛⱼ to Fₘⱼ, where Fₛⱼ=Fₘₐ+Fₛₖ, and Fₘⱼ=Fₘₖ+Fₛₐ. For example, when the distance between the housing of the sound-generating portion and the abutment portion is in a range of 3.8 mm to 5.5 mm, a corresponding deformation force is in a range of 0.27 N to 0.35 N. To ensure that the clamping force is in a range of 0.3 N to 0.4 N, the attraction force to be compensated needs to be in a range of 0.03 N (0.3−0.27=0.03) to 0.05 N (0.4−0.35=0.05). As can be seen from FIG. 13A, by setting appropriate parameters (such as k, K, m₁, m₂, or x₀), it may be possible to achieve that an increment of Fₖ and a decrement of F_{A} cancel each other out in the range of x₁ to x₂, so that the total clamping force Fⱼ remains substantially stable in the range of x₁ to x₂, thereby making the user experience provided by the ear-clip earphone consistent for users with different auricle thicknesses.

In some embodiments, the ear hook further provides a preload force, and a total clamping force may be maintained in an appropriate range by adjusting magnitudes of the preload force and the attraction force. As shown in FIG. 13B, the ear hook may simultaneously provide the deformation force Fₖ, a preload force F₀′, and the attraction force F_{A}. At this time, the clamping force of the ear hook on the large-ear user has exceeded an upper limit of the preload force. By reducing the preload force from F₀′ to F₀″, a clamping force Fⱼ′ provided by the ear hook as shown in FIG. 13B may be obtained. In a range of the minimum auricle thickness and the maximum auricle thickness, a curve corresponding to the clamping force Fⱼ′ is relatively flat and is in an appropriate clamping force range, which indicates that the cooperation between the preload force and the attraction force can improve the wearing stability and the comfort of the ear-clip earphone, and reduce the difference in clamping forces between the large-ear user and the small-ear user.

In some embodiments, the elastic coefficient of the ear hook may be in a range of 0.01 N/mm to 0.23 N/mm. Detailed description regarding the elastic coefficient of the ear hook may be found in FIG. 1 and related descriptions thereof.

In some embodiments, the ear hook may include a titanium sheet and a flexible layer wrapping an outer side of the titanium sheet. In some embodiments, two end portions of the titanium sheet in a length direction of the titanium sheet may be respectively connected to the housing and the abutment portion. In some embodiments, a dimension of the titanium sheet in a width direction may be in a range of 1.5 mm to 3 mm, and a dimension of the titanium sheet in a thickness direction may be in a range of 0.15 mm to 0.3 mm. More detailed descriptions regarding the material and shape of the ear hook may be found in FIG. 1 and related descriptions thereof.

In some embodiments of the present disclosure, by disposing the first magnet in the sound-generating portion and disposing the second magnet in the abutment portion, the clamping force is compensated based on the attraction force between the first magnet and the second magnet, where the greater the distance between the housing of the sound-generating portion and the abutment portion, the greater the clamping force, and the smaller a compensation of the clamping force by the attraction force, thereby the difference between the clamping force received by the small-ear user and the clamping force received by the large-ear user may be reduced, and the comfort for users with different auricle thicknesses may be improved.

The advantageous effects that may be brought by the embodiments of the present disclosure include, but are not limited to: (1) the ear hook provides a preload force to the housing of the sound-generating portion and the abutment portion, which may ensure that when the difference in the clamping forces received by the small-ear user and the large-ear user is reduced by reducing the elastic coefficient of the ear hook, the clamping force received by the small-ear user may remain unchanged, thereby improving the stability and comfort of users with different auricle thicknesses; (2) by disposing the first magnet within the sound-generating portion and disposing the second magnet within the abutment portion, the clamping force is compensated based on the attraction force between the first magnet and the second magnet, where the greater the distance between the housing of the sound-generating portion and the abutment portion, the greater the clamping force, and the smaller the compensation of the clamping force by the attraction force, thereby reducing the difference in clamping forces received by the small-ear user and the large-ear user, and improving the comfort of users with different auricle thicknesses. It should be noted that, different embodiments may generate different beneficial effects, and in different embodiments, the beneficial effects that may be generated may be a combination of any one or more of the above, or may be any other beneficial effects that may be obtained.

The basic concepts have been described above. It is apparent to a person of ordinary skill in the art that the above detailed disclosure is merely by way of example and is not intended to limit the present disclosure. Although not expressly stated herein, a person of ordinary skill in the art may make various modifications, improvements, and alterations to the present disclosure. These modifications, improvements, and alterations are suggested in the present disclosure, and thus, are still within the spirit and scope of the exemplary embodiments of the present disclosure.

Additionally, the present disclosure uses specific words to describe the embodiments of the present disclosure. For example, “one embodiment,” “an embodiment,” and/or “some embodiments” refer to a certain feature, structure, or characteristic related to at least one embodiment of the present disclosure. Therefore, it should be emphasized and noted that “an embodiment,” “one embodiment,” or “an alternative embodiment” referred to twice or more in different locations in the present disclosure does not necessarily refer to the same embodiment. Furthermore, certain features, structures, or characteristics in one or more embodiments of the present disclosure may be appropriately combined.

Furthermore, a person of ordinary skill in the art can understand that various aspects of the present disclosure can be illustrated and described through a plurality of patentable classes or situations, including any new and useful combination of processes, machines, articles of manufacture, or compositions of matter, or any new and useful improvement thereof. Accordingly, various aspects of the present disclosure may be entirely executed by hardware, may be entirely executed by software (including firmware, resident software, microcode, or the like), or may be executed by a combination of hardware and software. The above hardware or software may each be referred to as a “data block,” a “module,” an “engine,” a “unit,” a “component,” or a “system.” Furthermore, various aspects of the present disclosure may be embodied as a computer product located in one or more computer-readable media, wherein the product includes computer-readable program code.

The computer storage medium may comprise a propagated data signal containing computer program code, for example, on a baseband or as part of a carrier wave. The propagated signal may take various forms, including electromagnetic form, optical form, or the like, or a suitable combination thereof. A computer storage medium may be any computer-readable medium except for a computer-readable storage medium, wherein the medium may be connected to an instruction execution system, an apparatus, or a device to communicate, propagate, or transport a program for use. The program code located on the computer storage medium may be propagated by any suitable medium, including radio, cable, optical fiber cable, Radio Frequency (RF), or a similar medium, or any combination of the above media.

The computer program code required for operations of various parts of the present disclosure may be written in any one or more programming languages, including object-oriented programming languages such as Java, Scala, Smalltalk, Eiffel, JADE, Emerald, C++, C #, VB.NET, Python, or the like; conventional procedural programming languages such as C, Visual Basic, Fortran2003, Perl, COBOL2002, PHP, and ABAP; dynamic programming languages such as Python, Ruby, and Groovy; or other programming languages, or the like. The program code may be run entirely on a user computer, or may be run on the user computer as a standalone software package, or may be run partly on the user computer and partly on a remote computer, or may be run entirely on a remote computer or a processing device. In the latter case, the remote computer may be connected to the user computer through any network form, such as a Local Area Network (LAN) or a Wide Area Network (WAN), or may be connected to an external computer (e.g., via the Internet), or in a cloud computing environment, or may be used as a service, such as Software as a Service (SaaS).

Furthermore, unless expressly stated in the claims, the order of process elements and sequences described in the present disclosure, the use of numerals, letters, or other names is not intended to limit the order of processes and manners of the present disclosure. Although some presently useful inventive embodiments have been discussed through various examples in the above disclosure, it should be understood that such details are merely by way of example, and the appended claims are not limited to the disclosed embodiments. On the contrary, the claims are intended to cover all modifications and equivalent combinations that fall within the spirit and scope of the embodiments of the present disclosure. For example, although the system components described above may be implemented by hardware devices, these system components may also be implemented only through software solutions, such as by installing the described system on an existing processing device or a mobile device.

Similarly, it should be noted that for the purpose of simplifying the expression of the present disclosure and thereby assisting in understanding one or more inventive embodiments, in the preceding description of the embodiments of the present disclosure, sometimes various features may be grouped into a single embodiment, a figure, or the description thereof. However, this manner of disclosure does not mean that the object of the present disclosure requires more features than those mentioned in the claims. In fact, the features of an embodiment may be fewer than all the features of a single embodiment disclosed above.

In some embodiments, numerals describing the number of components and attributes are used. It should be understood that such numerals used in the description of the embodiments, in some examples, are modified by the words “about,” “approximate,” or “substantially.” Unless otherwise indicated, “about,” “approximate,” or “substantially” indicate that the stated numerals allow for a variation of ±20%. Accordingly, in some embodiments, the numerical parameters used in the description and the claims are all approximate values, and these approximate values may vary according to the characteristics required by individual embodiments. In some embodiments, the numerical parameters should consider the specified significant digits and should adopt a general rounding manner. Although the numerical domains and parameters used to ascertain the breadth of scope in some embodiments of the present disclosure are approximate values, in specific embodiments, the settings of such numerical values are as precise as possible within a feasible range.

For each patent, patent application, patent application publication, and other materials cited in the present disclosure, such as articles, books, descriptions, publications, documents, or the like, the entirety of each of these is hereby incorporated by reference into the present disclosure. With the exception of any prosecution history document inconsistent with or conflicting with the content of the present disclosure, and with the exception of any document (presently or later appended to the present disclosure) that limits the broadest scope of the claims of the present disclosure. It should be noted that if there is any inconsistency or conflict between the descriptions, definitions, and/or use of terminology in supporting materials of the present disclosure and the content described in the present disclosure, the descriptions, definitions, and/or use of terminology of the present disclosure shall prevail.

Finally, it should be understood that the embodiments described in the present disclosure are merely by way of example to illustrate the principles of the embodiments of the present disclosure. Other variations may also fall within the scope of the present disclosure. Therefore, merely by way of example and not limitation, alternative configurations of the embodiments of the present disclosure may be considered consistent with the teachings of the present disclosure. Accordingly, the embodiments of the present disclosure are not limited to the embodiments expressly introduced and described in the present disclosure.

1. An ear-clip earphone, comprising:
a sound-generating portion, wherein in a wearing state, the sound-generating portion is configured to be located in a concha cavity of a user and contact an inner wall of the concha cavity, the sound-generating portion including:
a housing having an accommodating cavity;
a sound-generating assembly accommodated in the accommodating cavity, wherein the sound-generating assembly is configured to convert an electrical signal into an audio signal; and
a sound outlet hole located on the housing and configured to guide out a sound generated by the sound-generating assembly;
an abutment portion, wherein in the wearing state, the abutment portion is configured to abut a rear side of an auricle of the user, and a battery is disposed in the abutment portion; and
an ear hook, wherein in the wearing state, the ear hook is configured to bypass an antihelix and a helix of the user, connect to the sound-generating portion and the abutment portion, and provide a clamping force for clamping the sound-generating portion and the abutment portion on two sides of the auricle;
and in a non-wearing state, the ear hook provides a preload force for abutting the sound-generating portion against the abutment portion.

2. The ear-clip earphone according to claim 1, wherein the ear hook has a first symmetry plane, the housing forms a first projection when projected onto the first symmetry plane, the abutment portion forms a second projection when projected onto the first symmetry plane, the ear hook forms a third projection when projected onto the first symmetry plane, and the third projection includes an inner contour curve; wherein:
the first projection and the second projection are in contact with each other, the first projection and the second projection have a first common tangent therebetween, the first common tangent is simultaneously tangent to the first projection and the second projection at a first tangent point, and the first tangent point serves as a first feature point; or the first projection and the second projection have an overlapping region, and in the overlapping region, an outer contour of the first projection and an outer contour of the second projection have two intersection points, and a midpoint of a connecting line of the two intersection points serves as the first feature point;
a point on the inner contour curve farthest from the first feature point serves as a second feature point;
a connecting line between the first feature point and the second feature point is defined as a first connecting line, a first auxiliary line is drawn from the second feature point toward a side biased toward the first projection, a first included angle between the first auxiliary line and the first connecting line has a first preset value range, the first preset value range is 27°-37°, or greater than 37° and less than or equal to 50°, an intersection point of a curve segment of the inner contour curve connected to the first projection and the first auxiliary line is defined as a third feature point, a connecting line between the third feature point and the second feature point is defined as a second connecting line, a portion of the inner contour curve corresponding to the second connecting line has a first arc length, a ratio between the first arc length and a length of the second connecting line is defined as a first arc-to-chord ratio, and the first arc-to-chord ratio is in a range of 1.10 to 1.25, or the first arc-to-chord ratio is greater than or equal to 1.05 and less than 1.10; and
a second auxiliary line is drawn from the second feature point toward a side biased toward the second projection, a second included angle between the second auxiliary line and the first connecting line has a second preset value range, the second preset value range is 34°-49°, or greater than or equal to 20° and less than 34°, an intersection point of a curve segment of the inner contour curve connected to the second projection and the second auxiliary line is defined as a fourth feature point, a connecting line between the fourth feature point and the second feature point is defined as a third connecting line, a portion of the inner contour curve corresponding to the third connecting line has a second arc length, a ratio between the second arc length and a length of the third connecting line is defined as a second arc-to-chord ratio, and the second arc-to-chord ratio is in a range of 1.11 to 1.24, or the second arc-to-chord ratio is greater than 1.24 and less than or equal to 1.40.

3. The ear-clip earphone according to claim 2, wherein a point on the first projection closest to the second feature point serves as a fifth feature point, a connecting line between the fifth feature point and the second feature point serves as a fourth connecting line, an extension line of the fourth connecting line intersects the first projection at a sixth feature point, a connecting line between the fifth feature point and the sixth feature point is defined as a fifth connecting line, a curve segment of the first projection corresponding to the fifth connecting line has a third arc length, a ratio between the third arc length and a length of the fifth connecting line is defined as a third arc-to-chord ratio, and the third arc-to-chord ratio is in a range of 1.4 to 1.7, or the third arc-to-chord ratio is greater than 1.7 and less than or equal to 1.8.

4. The ear-clip earphone according to claim 1, wherein in a state where the abutment portion is held and the sound-generating portion is freely placed such that the sound-generating portion faces the ground along a gravity direction, the abutment portion contacts the sound-generating portion.

5. The ear-clip earphone according to claim 1, wherein the preload force is in a range of 0.01 N to 0.25 N.

6. The ear-clip earphone according to claim 5, wherein an elastic coefficient of the ear hook is in a range of 0.01 N/mm to 0.24 N/mm.

7. The ear-clip earphone according to claim 5, wherein when a distance between the housing of the sound-generating portion and the abutment portion varies between 3.8 mm and 5.5 mm, the clamping force is in a range of 0.1 N to 0.2 N.

8. The ear-clip earphone according to claim 5, wherein when a distance between the housing of the sound-generating portion and the abutment portion is 5.5 mm, the clamping force is in a range of 0.14 N to 0.2 N.

9. The ear-clip earphone according to claim 5, wherein when a distance between the housing of the sound-generating portion and the abutment portion varies between 3.8 mm and 5.5 mm, a variation of the clamping force does not exceed 0.20 N.

10. The ear-clip earphone according to claim 1, wherein:
the ear hook includes a titanium sheet and a flexible layer wrapping an outer side of the titanium sheet, two end portions of the titanium sheet in a length direction of the titanium sheet are respectively connected to the housing and the abutment portion, a dimension of the titanium sheet in a width direction is in a range of 1.5 mm to 3 mm, and a dimension of the titanium sheet in a thickness direction is in a range of 0.15 mm to 0.3 mm.

11. The ear-clip earphone according to claim 1, wherein a region of the housing abutting against the abutment portion is provided with a flexible body.

12. The ear-clip earphone according to claim 1, wherein a first magnet is disposed in the sound-generating portion, a second magnet is disposed in the abutment portion, and the first magnet and the second magnet attract each other to compensate the clamping force provided by the sound-generating portion and the abutment portion.

13. The ear-clip earphone according to claim 2, wherein two arc segments with equal arc lengths are respectively determined on the inner contour curve of the third projection and are centered at the second feature point, an arc length of each of the two arc segments is in a range of 2.5 mm to 3.5 mm.

14. The ear-clip earphone according to claim 13, wherein when the sound-generating portion and the abutment portion are not in contact with each other, a connecting line between ends of the two arc segments away from the second feature point corresponds to an arc segment, and an arc-to-chord ratio between an arc length of the arc segment and a length of the connecting line is in a range of 1.00 to 1.10.

15. The ear-clip earphone according to claim 13, wherein when the sound-generating portion and the abutment portion abut each other, a connecting line between ends of the two arc segments away from the second feature point corresponds to an arc segment, and an arc-to-chord ratio between an arc length of the arc segment and a length of the connecting line is in a range of 1.03 to 1.12.

16. The ear-clip earphone according to claim 12, wherein the first magnet and the second magnet are respectively disposed on an inner side of a region where the sound-generating portion and the abutment portion abut each other.

17. The ear-clip earphone according to claim 12, wherein at least one of the first magnet or the second magnet includes a Halbach magnet array composed of a plurality of magnets.

18. The ear-clip earphone according to claim 12, wherein a magnet of the sound-generating assembly serves as the first magnet, and the sound-generating assembly further includes a diaphragm and a voice coil, and the voice coil is connected to the diaphragm and located in a magnetic field of the magnet of the sound-generating assembly.

19. The ear-clip earphone according to claim 18, wherein in an energized state, the voice coil drives the diaphragm vibrate, and the magnet is disposed relative to the diaphragm on a side of the sound-generating assembly near the concha cavity.

20. The ear-clip earphone according to claim 1, wherein the sound-generating assembly includes a third magnet, and a first magnet outside the sound-generating assembly is closer to a second magnet than the third magnet.
